(19) United States
(12) Patent Application Publication
(10) Pub. No.: US 2024/0400414 A1
(43) Pub. Date: Dec. 5, 2024

(54) WATER PURIFICATION

(71) Applicant: Ecovap, Inc., Provo, UT (US)

(72) Inventor: Michael J. PATEY, Orem, UT (US)

(21) Appl. No.: 18/697,244

(22) PCT Filed: Oct. 3, 2022
(86) PCT No.: PCT/US2022/045517

§ 371 Date: Mar. 29, 2024

Related U.S. Application Data
(60) Provisional application No. 63/251,172, filed on Oct. 1, 2021.

(51) Int. Cl. C02F 1/08; B01D 1/00; B01D 1/22; B01D 5/00; C02F 1/04; C02F 1/14; F28C 3/08

(52) U.S. Cl. CPC C02F 1/08; B01D 1/0035; B01D 1/0082; B01D 1/0088; B01D 1/22; B01D 5/006; B01D 5/009; C02F 1/048; C02F 1/14; F28C 3/08; C02F 2209/03

(57) ABSTRACT

A water purification system can include an enclosed chamber having an evaporation region and a condensation region. The evaporation region can include an evaporation tower with a series of shelves to receive and increase a surface area of impure water while cascading downward from an upper shelf to lower shelves therebeneath as water evaporates therefrom to form water vapor within the enclosed chamber, and a fluid directing assembly to cyclically transport the impure water from a reservoir source to the upper shelf. The condensation region can include a purified water-receiving vessel and a plurality of water collectors. Individual water collectors of the plurality of water collectors can include an exterior surface coolable to a temperature below a dew point of air carrying the water vapor and shaped to channel water formed thereon by condensation to the purified water-receiving vessel.

### BACKGROUND

There are several techniques used to separate water from various contaminants or impurities, such as hydrocarbons, salts, debris, dirt/clay, coal, hazardous material, or the like. Sources of impure water can be, for example, industrial wastewater, which comes from various industries, such as from facilities including chemical plants, fossil-fuel power stations, food production facilities, iron and steel plants, mines and quarries, nuclear plants, and others. Evaporation from bodies of water (including tailings ponds, storage ponds, evaporation ponds, percolation ponds, or the like) has been used to separate various types of contaminants from water. In connection with water evaporation, collection of water formed by condensation from water vapor can be a good way to generate purified water, e.g., more purified than as may be present in the source body of water, which may be contaminated, salinated, etc. For example, salt evaporation can be used to produce salt from seawater, or can be used to dispose of brine or brackish water from desalination plants. Mining, mineral processing, and tailings operations can use evaporation to separate ore, minerals, tailings or other material from water. The oil and gas industry can use evaporation to separate various hydrocarbons from water. Evaporation can also be used to separate water from various types of hazardous or non-hazardous impurities or waste, reducing its weight and volume to make it more easily transportable and stored. Furthermore, by collecting water formed by condensation from water vapor, a good source of more purified water can be generated for a variety of uses, including as drinking or potable water, safe irrigation water, safer water for use in industrial processes, or the like.

### BRIEF DESCRIPTION OF THE DRAWINGS

FIG. 1 is a schematic view of an example water purification system in accordance with the present disclosure.

FIGS. 2A and 2B are side and top schematic views, respectively, of another example water purification system in accordance with the present disclosure.

FIGS. 3A and 3B are side and top schematic views, respectively, of additional detail depicting the example water purification system of FIGS. 2A and 2B in accordance with the present disclosure.

FIG. 4A is a front plan view, left and right side or end plan views, a top plan view, and a bottom plan view of an example evaporation panel in accordance with the present disclosure.

FIG. 4B is an upper left perspective view of the example evaporation panel shown in FIG. 4A in accordance with the present disclosure.

FIG. 5 is a front plan view, left and right side or end plan views, a top plan view, and a bottom plan view of the evaporation panel shown in FIG. 4 in accordance with the present disclosure.

FIG. 6 is a front plan view, left and right side or end plan views, a top plan view, and a bottom plan view of another example evaporation panel with enlarged evaporative airflow channels and cross-supports in accordance with the present disclosure.

FIG. 7 is a cross-sectional view of two example evaporation panels of an evaporation panel assembly or system that is usable to form an evaporation tower, including a close-up detailed portion thereof, joined together orthogonally to form an example evaporator panel assembly, more specifically an L-shaped sub-assembly, in accordance with the present disclosure.

FIG. 8 is a close-up, front plan, partial view showing how two example evaporation panels of an evaporation panel system can be stacked vertically to form an example evaporation panel assembly in accordance with the present disclosure.

FIG. 9 is a perspective view of ten example evaporation panels of an evaporation panel system joined together to form an example evaporator panel assembly, more specifically a cube-shaped sub-assembly, in accordance with the present disclosure.

FIG. 10 is a front plan, partial view of an example evaporation panel of an evaporation panel system or assembly usable in forming an evaporation tower in accordance with the present disclosure.

FIG. 11 is a top cross-sectional, partial plan view, taken along section A-A of FIG. 10, of an example evaporation panel in accordance with the present disclosure.

FIG. 12 is a close-up view of a portion of the example evaporation panel of FIG. 10, taken within the dashed lines thereof, having impure water loaded thereon in accordance with the present disclosure.

FIG. 13 is a top cross-sectional, partial plan view, taken along section B-B of FIG. 12, of an example evaporation panel in accordance with the present disclosure, which further shows an example airflow pattern generated by a leading edge of a symmetrical airfoil-shaped vertical water column.

FIG. 14A is a top plan view of several different example sub-assemblies that can be formed to assemble larger and more complex evaporation panel assemblies in accordance with examples of the present disclosure.

FIG. 14B is a top plan view of an arrangement of twenty example evaporation panels of an evaporation panel system joined together to form four pi-shaped sub-assemblies (4 teeth), which are also further joined together to form an example evaporation panel assembly in accordance with the present disclosure.

FIG. 14C is a top plan view of an arrangement of sixty-nine example evaporation panels of an evaporation panel system joined together to form nine pi-shaped sub-assemblies (some symmetrical and some asymmetrical), which are also further joined together to form an example evaporation panel assembly in accordance with the present disclosure.

FIG. 15 is a perspective view illustrating two example evaporation panel assemblies spaced apart from one another by a small distance or gap, which can be stacked and used as multiple evaporation towers, and which provide example structures including a structural stairway, a passageway, upper platforms, and safety barriers or walls, and cantilevered bridging portions, all formed or defined in this example at least in part from assembled evaporation panels or evaporation panel sub-assemblies in accordance with the present disclosure.

FIG. 16 is a top plan view illustrating four example evaporation panel assemblies in the form of four evaporation towers, where the four individual evaporation panel assemblies are grouped together, but spaced apart from one another, by a small distance or gap in accordance with the present disclosure.

FIG. 17 is a perspective view illustrating an example impure water delivery system including an example evaporator panel sub-assembly (cube-shaped) positioned over a body of impure water on a platform with various example impure water delivery systems, e.g., water delivery pan, in accordance with the present disclosure.

FIG. 18A is a side plan view of an example evaporation panel positioned relative to an example bi-directional channeling trough in accordance with the present disclosure.

FIG. 18B is a top plan view of an example water delivery trough system connected together to leave a water supply opening, e.g., over an opening of a vertical support beam assembly of an evaporation panel assembly, in accordance with the present disclosure.

FIG. 18C is a side plan view of an example (partially assembled) water delivery trough system with a fluid delivery pipe associated therewith in accordance with the present disclosure.

FIG. 19 depicts an example condensation region of an enclosed chamber of a water purification system, as well as various detailed views of an example condensation assembly and various example parts of the condensation assembly in accordance with the present disclosure.

FIG. 20 depicts an example condensation assembly and various example parts of the condensation assembly in accordance with the present disclosure.

FIG. 21 is a flowchart depicting an example method of purifying water in accordance with the present disclosure.

### DETAILED DESCRIPTION

In accordance with examples of the present technology, a water purification system, a condensation assembly, and a method of purifying impure water is disclosed. These systems, devices (assemblies), and methods provide a way of using impure water from an impure water source, e.g., brine, brackish water, seawater, produced water, effluent water, contaminated water, storm runoff, river water, pond or lake water, gray water, industrial wastewater, irrigation water, mining wastewater, oil or gas wastewater, etc., and removing dissolved and/or dispersed solids therefrom to generate a more purified water. The water purification systems described herein are based on condensing water vapor, which in most instances is relatively pure when the water vapor is condensed and collected. In some instances, if the impure water source includes evaporable impurities, such as volatile organic compounds (VOCs), there may be some toxic airborne compounds that get carried with the water vapor that may likewise be condensed with the more purified water that is collected. If the levels are low enough, the water may still be usable as collected. However, if collected and the VOCs level is too high for a given application, the collected water could then be run through the evaporation and condensation cycle a second time (or a third time, etc.) until a desired or usable water purity is reached.

The water purification systems of the present disclosure can be effective for treating impure water having a relatively high concentration of contaminants or other impurities, e.g., salt, potash, gravel, clay, chalk, stone, oil shale, oil or gas collection byproducts, metal, industrial waste, coal or coal seam gas (CSG), effluent contaminant, etc. For example, impure water having up to about 25,000 parts per million (ppm), up to about 50,000 ppm, up to about 100,000 ppm, up to about 150,000 ppm, or even up to about 250,000 ppm (by weight) in some cases can be purified using the water purification systems described herein. The water purity achieved can depend on the type of contaminant present, but in many instances can be used to achieve purified water having up to about 2,000 ppm, up to about 1,000 ppm, up to about 500 ppm, up to about 400 ppm, up to about 250 ppm, or up to about 100 ppm of impurities using only a single treatment cycle, e.g., evaporation followed by water vapor condensation to yield the purified water. If more purity is desired than what is collected by a single cycle, the collected water can be run through the same (or an adjacent) water purification system to achieve further water purity.

With respect to the term “purified” water, or when referring to “purifying” water, it is noted that this is a relative term. In other words, purification of impure water indicates that the water at the end of the process has enhanced purity relative to the impure water from the water source. This does not imply that the water is completely pure. In some instances, the water may be pure enough to use as drinking water (potable water), but in other cases, it may be pure enough for other uses other than drinking water for which the impure water source may not have been acceptable for use, e.g., watering of plants, cooking, etc. For the generation of potable water suitable for drinking, the EPA has published the National Primary Drinking Water Regulations (NPDWR), which includes standards limiting the levels of contaminants allowed in drinking water (in the US). These standards include maximum concentrations of microorganisms, disinfectants, disinfection byproducts, inorganic chemicals, organic chemicals, and radionuclides. Water can be considered potable in the context of the present disclosure if it meets or exceeds the water purity standards based on Maximum Contaminant Level (MCL) requirements of the NPDWR published as EPA 816-F-09-004 (May 2009). Notably, water that is not considered potable may still be safely drinkable if one or a few of these compounds are found to be present at slightly higher concentrations. Furthermore, water purity standards for drinking water may be different in other countries. Thus, in accordance with the present disclosure, water that is referred to as “drinkable” can be viewed flexibly in the context of local regulations and/or needs for drinkable water at a given location internationally. Again, if a desired purity is not reached, additional purification cycles can be used to further purify the previously treated water.

In accordance with this, a water purification system, for example, can include an enclosed chamber having an evaporation region and a condensation region. The evaporation region in this example can include an evaporation tower including a series of shelves to receive and increase a surface area of impure water while cascading downward from an upper shelf to lower shelves therebeneath as water evaporates therefrom to form water vapor within the enclosed chamber, as well as a fluid directing assembly to cyclically transport the impure water from a reservoir source to the upper shelf. The condensation region in this example can include a purified water-receiving vessel, and a plurality of water collectors. Individual water collectors of the plurality of water collectors can include an exterior surface coolable to a temperature below a dew point of air carrying the water vapor and shaped to channel water formed thereon by condensation to the purified water-receiving vessel.

In another example, a condensation assembly can include a plurality of water collectors to condense water vapor and form purified water. At least one water collector thereof can include an interior surface defining a cooling channel, the cooling channel to transport coolant therethrough when present, and an exterior surface providing a path for runoff of the purified water. The exterior surface can be being thermally coupled to the interior surface of the cooling channel facilitating cooling of the exterior surface by heat exchange between the inner surface and the exterior surface. The condensation assembly can also include a coolant return fluidly coupled to the at least one water collector as part of a closed-loop system to cycle and cool coolant after exiting the cooling channel to be re-supplied to the cooling channel of the at least one water collector, and a purified water-receiving vessel fluidly coupled to the exterior surface of the at least one water collector to collect the purified water after the runoff from the exterior surface.

In another example, a method of purifying impure water in an enclosed chamber can include generating water vapor from impure water within an evaporation region of an enclosed chamber to form humidified air by cascading the impure water downward from shelf to shelf of an evaporation tower. The method can also include condensing the water vapor within a condensation region of the enclosed chamber at an exterior surface of a water collector that is cooled to a temperature below a dew point of the humidified air holding the water vapor to generate purified water by condensation at the exterior surface of the water collector; and collecting the purified water formed by condensation as runoff from the exterior surface into a purified water-receiving vessel.

It is also noted that reference throughout this specification to “one embodiment,” “an embodiment,” “an example,” “one example,” “examples,” “etc.,” or similar language means that a particular feature, structure, or characteristic described in connection therewith is included in at least one example of the present disclosure, but also may be applicable to other examples. Thus, appearances of the phrases such as “in one embodiment,” “in one example,” or similar language throughout this specification may, but do not necessarily, all refer to the same embodiment. For example, when discussing any one of the embodiments herein, e.g., water purification systems, condensation assemblies, and any related systems and/or methods, each of these discussions can be considered applicable to the other examples, whether or not they are explicitly discussed in the context of that specific example. As such, features, structures, or characteristics of that disclosure or shown in the FIGS. herein may not be specifically shown and/or described in detail in every instance to avoid obscuring aspects of the disclosure.

The terms “remediation,” “evaporative separation,” or “purification” of water can both be used herein, as contaminants are being effectively separated from an impure water source. That being stated, the contaminants are removed from the water by an evaporative process. Thus, the water is being “purified” when separated and recollected by condensation. Thus, it goes through multiple phase changes, e.g., from liquid to vapor and then back to liquid. Thus, the impure water is separated from some or essentially all of the contaminants, which can then be collected as purified water after condensation. The term “purified” does not infer that it is completely pure, but rather, in a more purified form than the original impure water from the body of impure water or impure water source.

Likewise, the “impure water” is used to broadly include any type of water that has been adversely affected in quality by anthropogenic (human activity) influence, or which has other material therein (even naturally) for which there is a desire to separate that material from water. Thus, impure water can be, for example, wastewater which includes produced water, effluent water, or any other type of contaminated water that may benefit from the use of the evaporation panels, evaporation panel systems, evaporation panel sub-assemblies and assemblies, evaporation towers, evaporative separation systems, methods, and the like described herein. Furthermore, “impure water” also includes bodies of water with any material where evaporative separation may be desirable, whether caused by human activity or not, or whether that material is technically “waste” or not. For example, the term “impure water” can also include bodies of water that include large natural mineral content for which evaporable separation may be beneficial. Thus, impure water of any type that can be separated from “contaminants” or even from otherwise “desirable material,” e.g., evaporation to concentrate a salt for salt recovery, that can be concentrated by water evaporation is referred generally herein as “impure water,” regardless of its source.

Reference will now be made to certain FIGS. that represent specific examples of the present disclosure. The FIGS. are not necessarily to scale, and various modifications to the examples shown can be carried out in accordance with examples of the present disclosure. Additionally, reference numerals will be used throughout as they relate to a specific type of structure, even if that similar structure from embodiment to embodiment is not identically shaped, configured, or located. Each FIG. may include reference numerals not specifically described when discussing that specific illustration, but which may be described elsewhere herein. Likewise, discussion of structures on a specific illustration may not be numerically identified, but will be numerically identified elsewhere herein.

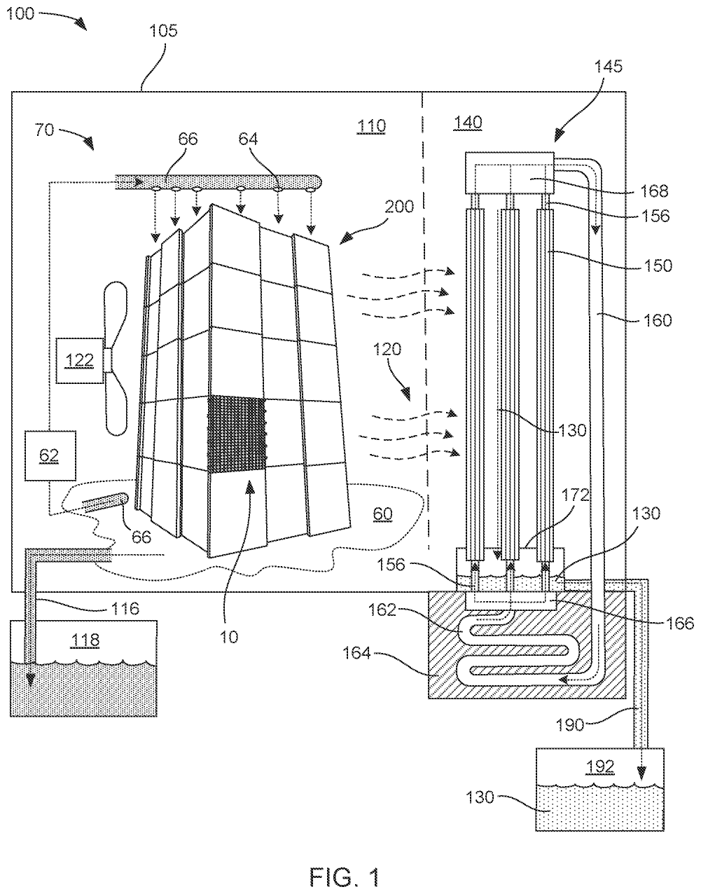

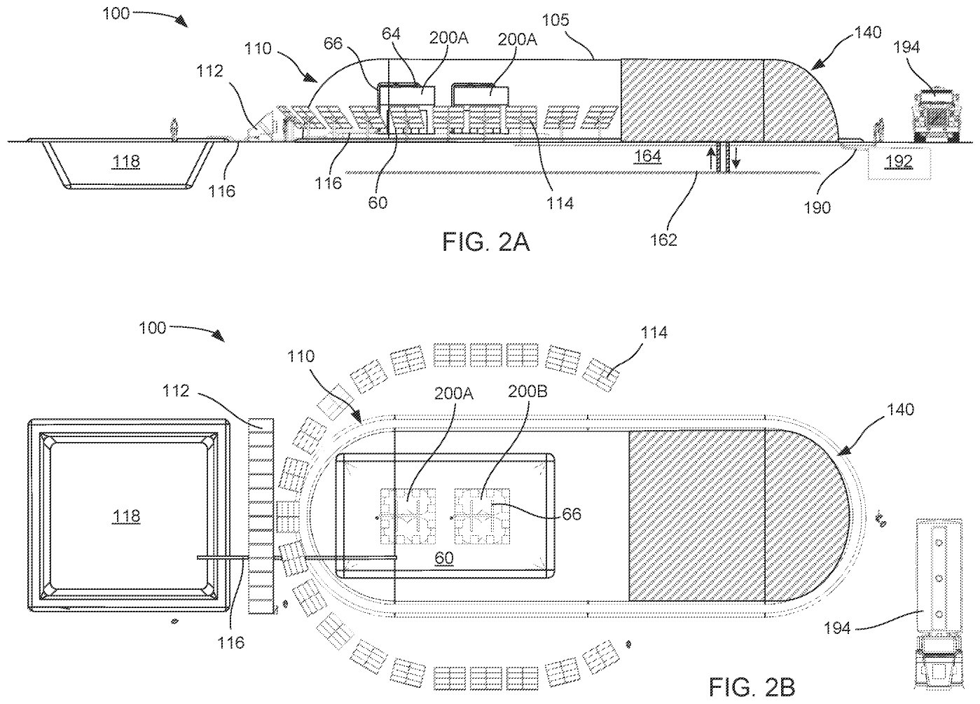

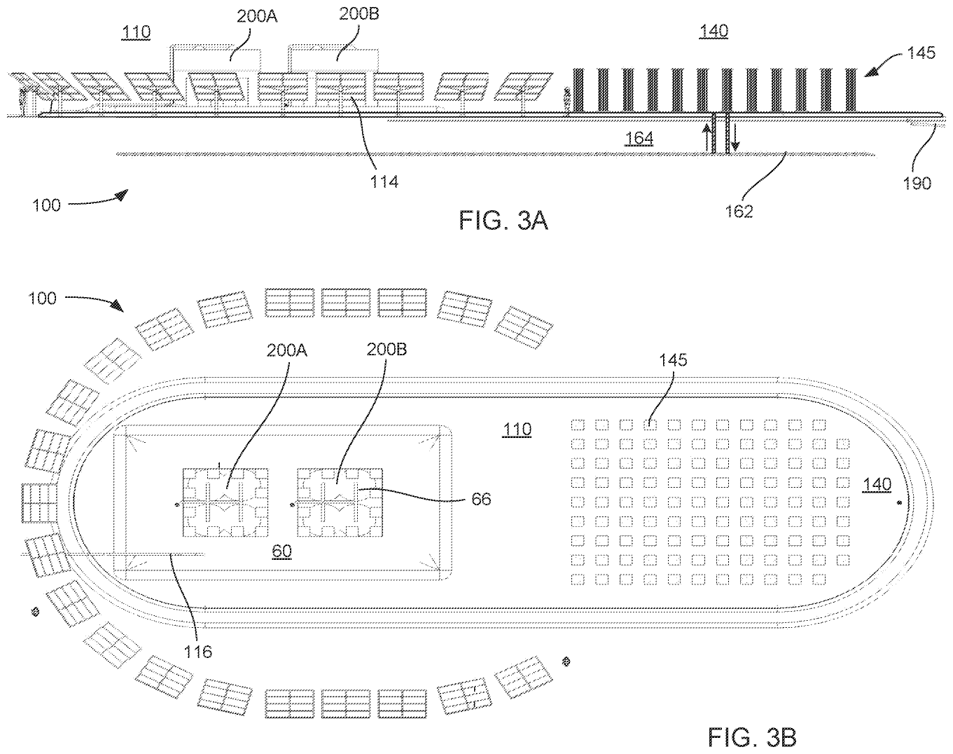

Referring now to the FIGS., in FIG. 1, a schematic representation of a water purification system is shown at 100. In this example, the water purification system includes an enclosed chamber 105 including an evaporation region 110 and a condensation region 140. In some examples, the evaporation region can be partially enclosed with a transparent or translucent material, a black or heat absorbing material, or a combination thereof, e.g., black or heat absorbing material with transparent or translucent windows. The transparent or translucent portion(s) can, for example, receive redirected sunlight energy for additional heating, as shown in FIGS. 2A-3B. The condensation region can be partially enclosed with a white, heat resistant, or reflective material to retain cool air in this region to assist with the condensation of the water vapor generated in the evaporation region.

In some examples, the evaporation region can include an evaporation tower 200 including a series of shelves to receive and increase a surface area of impure water while cascading downward from an upper shelf to lower shelves therebeneath as water evaporates therefrom to form water vapor 120 within the enclosed chamber. The evaporation region also can include a fluid directing assembly 70 to cyclically transport the impure water from a reservoir source 60 to the upper shelf of the evaporation tower.

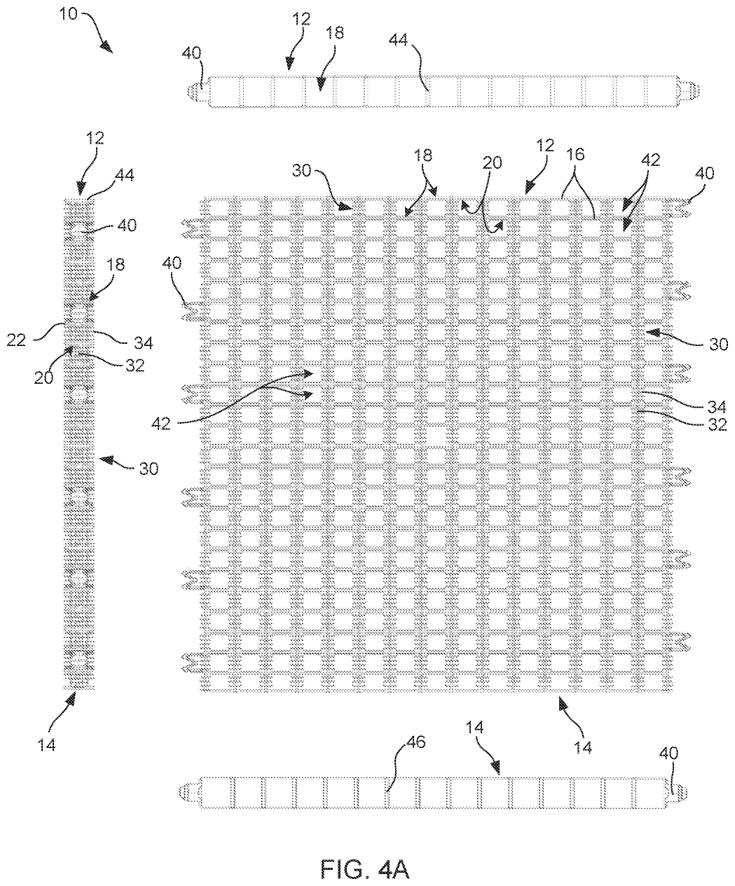

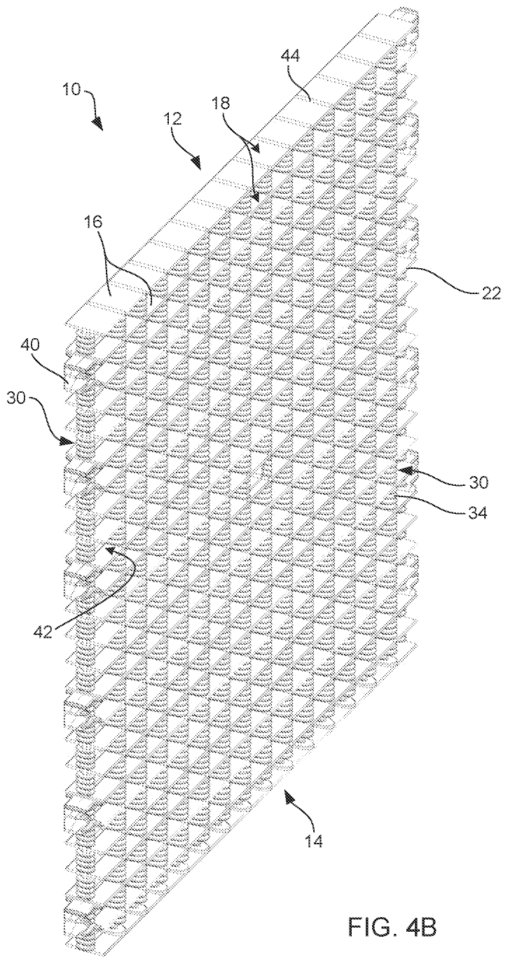

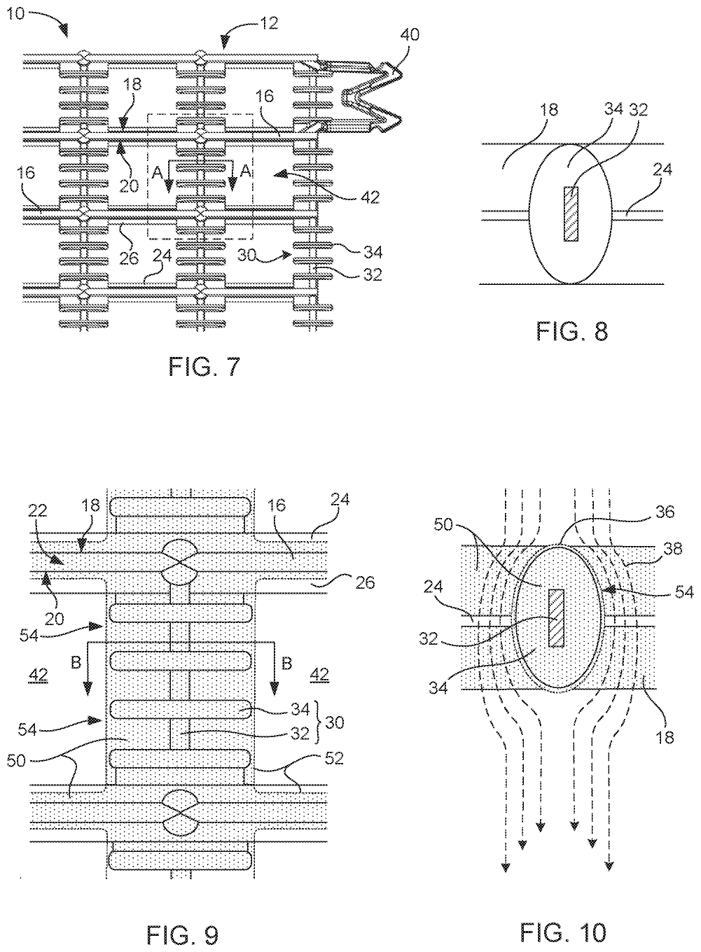

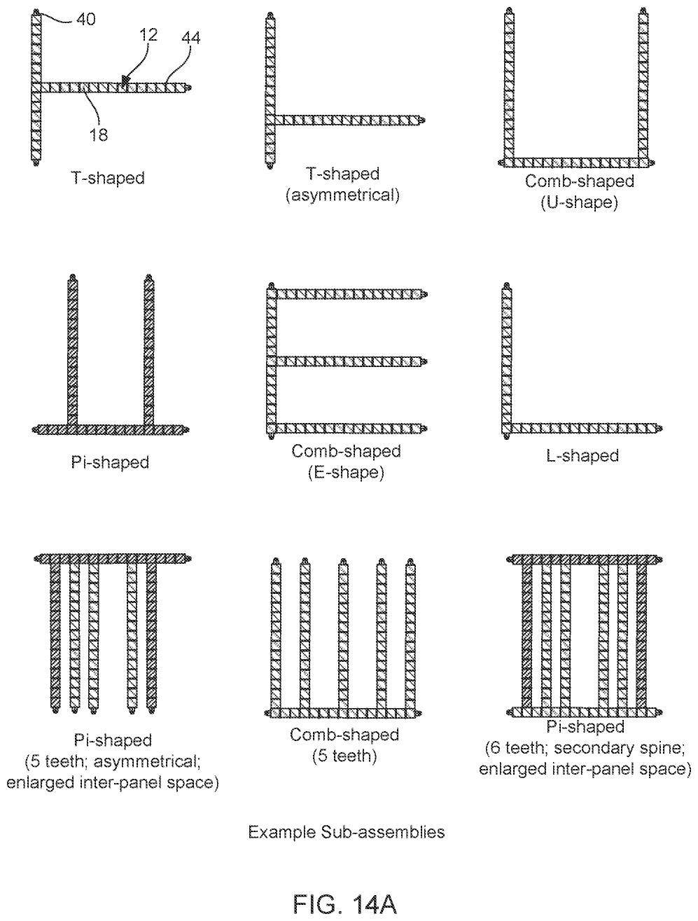

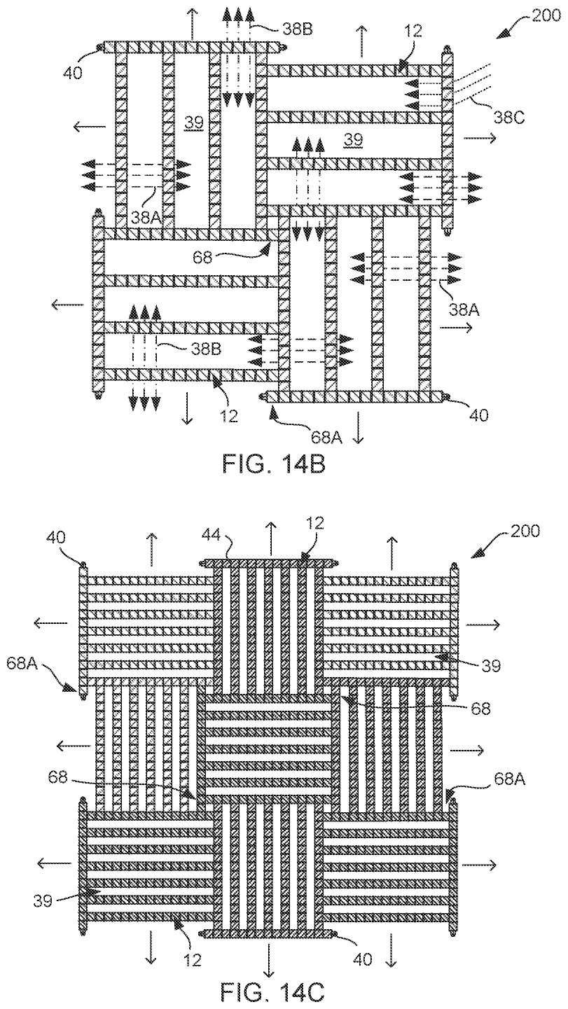

The evaporation tower 200 can be constructed of an evaporation panel assembly, with a plurality of evaporation panels 10 connected together, as described in more detail in FIGS. 4A-16. For example, the plurality of evaporation panels can be arranged in evaporation panel sub-assemblies (See FIG. 14A), and the evaporation panels can individually include a plurality of horizontally oriented upper evaporation shelves positioned over a series of lower evaporation shelves, which in some examples, include multiple evaporation panels connected orthogonally together. The series of shelves can be horizontally oriented and vertically stacked and separated by support columns. The support columns can include a plurality of stacked and spaced apart evaporation fins oriented in parallel with the series of evaporation shelves (See FIG. 4A, for example). In some examples, the evaporation fins can have the shape of a perpendicular cross-section of an airfoil (See FIGS. 7-10). Individual evaporation panels can include, for example, a plurality of female receiving openings which are individually bordered by two evaporation shelves and two support columns, and a plurality of male connectors positioned at both lateral ends of the respective evaporation panel joined at one or both ends with corresponding female receiving openings of orthogonally oriented evaporation panels.

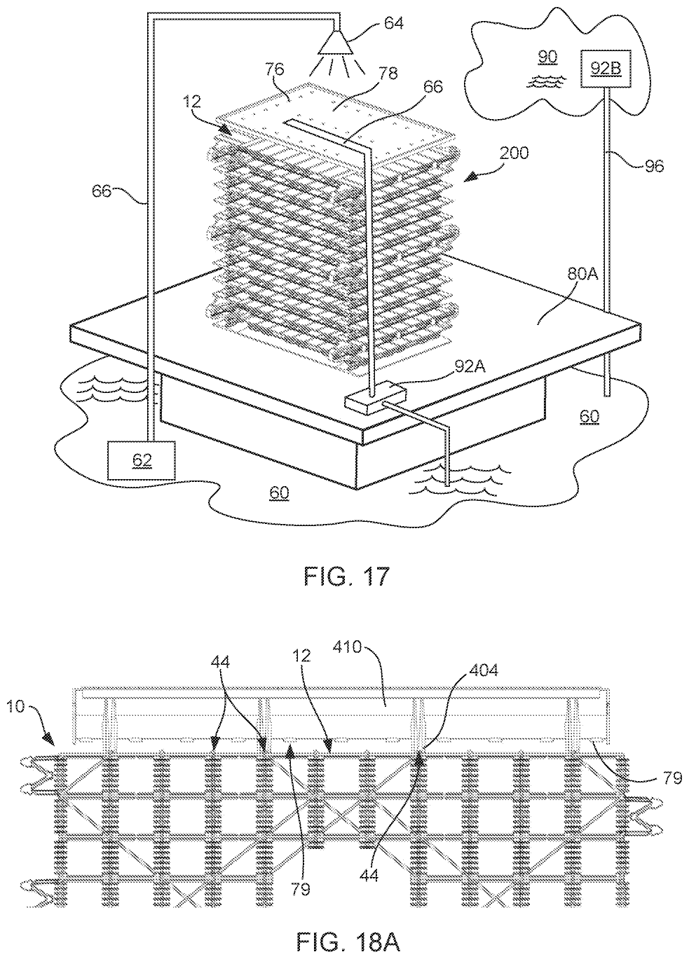

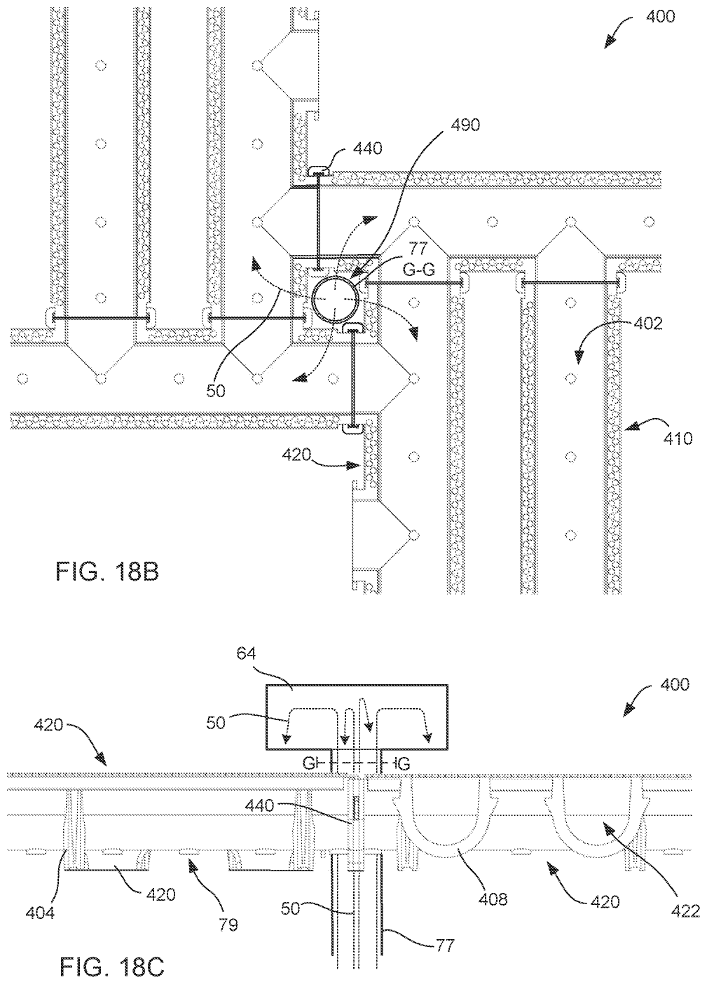

The fluid directing assembly 70 can include, for example, a water pump 62 and a water distributor 64 positioned at an upper surface of the evaporation tower 200. The water distributor can include a sprayer nozzle (as shown), a distribution pan (See FIG. 17 at 78), a distribution trough (See FIGS. 18A-18C), or a combination thereof. The fluid directing assembly can likewise include a delivery pipe or tube 66 to transport impure water from the body of impure water 60 (or impure water source), via the water pump, up to the water distributor, for example. As water vapor 120 evaporates from the impure water primarily while cascading down the evaporation tower, the body of impure water becomes more concentrated with impurities. To keep the system running properly, the more concentrated impure water can be channeled from the impure body of water to a waste pond 118 (or pit) via a waste-removal pipe 116. Additional impure water (that may be less concentrated with impurities) can then replace a portion of the impure water for continued processing. For example, as mentioned, impure water having up to about 25,000 parts per million (ppm), up to about 50,000 ppm, up to about 100,000 ppm, up to about 150,000 ppm, or even up to about 250,000 ppm (by weight) in some cases can be purified using the water purification systems described herein. When the impurities get too high, the system may not be as effective at operating as designed. Thus, a system for removing highly concentrated impure water can work well along with a separate system (not shown) for replenishing the impure water with something with a lower concentration of impurities. In additional detail, in some examples, optionally, there may be a fan or blower 122 (or some other mechanism) to push the water vapor from the evaporation region 110 to the condensation region.

The condensation region 140 can include a purified water-receiving vessel. The purified water-receiving vessel can include, for example, a purified water-receiving pan 172 and/or a purified water-receiving tank 192 (or secondary purified water-receiving vessel when both are present), connected by a purified water line 190. Thus, one or multiple purified water-receiving vessels can be used. The evaporation region can also include a condensation assembly 145, which may include a plurality of water collectors 150. Individual water collectors can include an exterior surface coolable to a temperature below a dew point of air carrying the water vapor 120 and can be shaped to channel or allow for gravity flow of purified water 130 formed thereon by condensation, which can be received at a purified water-receiving vessel, e.g., purified water-receiving pan and/or purified water-receiving tank.

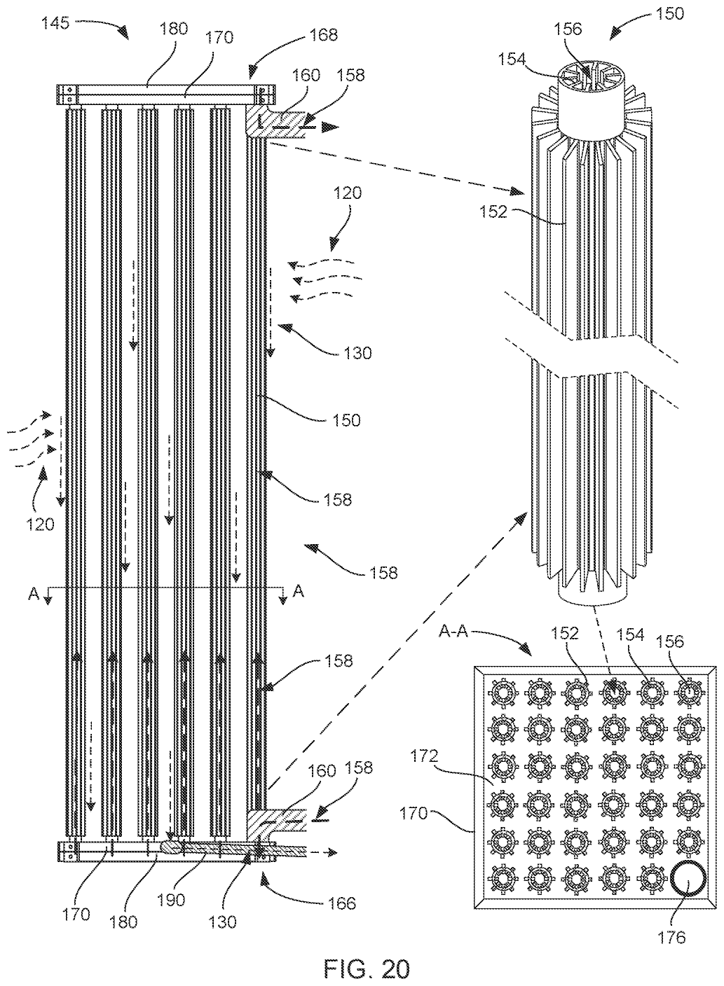

In this example, the water collectors 150 are vertically oriented pillars or posts. In some examples, an exterior surface of the individual water collectors include a plurality of exterior condenser fins (See FIG. 20 at 152). The individual water collectors can include a cooling channel 156 therethrough so that the exterior surface of individual water collectors are thermally coupled to the cooling channel to cool the exterior surface by heat exchange, e.g., using a coolant. Examples of coolant that can be used are any fluid that can be cooled remotely having a viscosity suitable to flow through the cooling channel. In one example, the coolant can include a glycol coolant, e.g., a glycol or a mixture of a glycol and water. In further detail, the cooling channel (within the water collectors) can be part of a closed loop system that is fluidly arranged to cycle the coolant from within the individual water collector to a cooling area at a distal location. There, the coolant that was previously warmed by heat exchange while within the cooling channel is cooled for cycling back to within the cooling channel. In one example, the distal location can be at a sub-surface cooling region 164, e.g., underground, underwater, etc. For example, even in hot climates, the temperature beneath the surface of the earth can be from about 60° F. to about 70° F. Thus, by burying (or submerging) the sub-surface cooling portion 162 of a coolant return 160, the coolant can be cooled sufficiently by geothermal cooling to return to the cooling channel of the water collectors to generate condensation on a surface thereof. The coolant return be in the form of any coolant channeling line suitable for a closed-loop system (with the cooling channel(s) of the water collector(s) and in some instances with various fluid directing manifolds), and can include a coolant pipes, coils, valves, pumps, connection fittings, charging openings, single or multiple stage cooling apparatuses, and/or the like.

In some examples, from about 2 to about 128 individual water collectors 150 can be present on a condensation assembly 145. There can likewise be many condensation assemblies within the condensation region 140 of the water purification system 100 (not shown, but shown at FIGS. 2A-3B). As mentioned, individual water collectors can independently include a cooling channel 156, and multiple cooling channels of multiple water collectors can be fluidly arranged in parallel as shown. In some examples, there can likewise be multiple cooling channels collectively connected in series with fluidics at the cooling area, e.g., underground, underwater, etc. In the example shown, cooling channels are fluidly arranged in parallel to flow coolant in an upward direction, with a common coolant return 160 to channel the warmed coolant underground or underwater for re-cooling and reuse within the closed-loop system. This particular arrangement utilizes a coolant supply manifold 166 and a coolant return manifold 168 to both direct coolant through the closed loop system. As a note, the purified supply manifold is shown at the bottom of the water collectors and the purified return manifold is shown at the top of the water collectors. This provides for upward flow of the coolant through the water collectors via a coolant channel. However, condensation assemblies may be arranged so that the coolant supply manifold is present at the top of the water collectors and the coolant return manifold is positioned at the bottom of the water collectors for downward flow of coolant through the coolant channel of the water collectors. Furthermore, in this example, the purified water-receiving pan 172 is a separate structure relative to the coolant supply manifold, but in some examples shown hereinafter, the purified water-receiving pan can be a pan portion of the coolant supply manifold (of the coolant return manifold in examples where coolant is flows in a downward direction).

Referring now to FIGS. 2A-3B, an example water purification system 100 is shown in four views, namely multiple side perspective views including a view of underground structures at FIGS. 2A and 3A, and multiple top views at FIGS. 2B and 3B. FIGS. 2A and 2B depict the enclosed chamber 105 including a cover or bubble of a transparent material at the evaporation region 110 and a white, heat resistant, and/or reflective material at the condensation region 140. Other enclosed chamber structures could likewise be used, including framed structures, e.g., greenhouse-type structures or even more permanent structures. FIGS. 3A and 3B, on the other hand, show a water purification system without the enclosed chamber so that the condensation region is more visible. In further detail, there are structures on the outside of the enclosed chamber shown as well in FIGS. 2A and 2B, and to a lesser extent in FIGS. 3A and 38, such as a waste pond 118 (or pit) that delivers concentrated impure water from a body of impure water 60 within the enclosed chamber via a waste-removal pipe. A pump (not shown) or other method of transporting concentrated impure water to the waste pond can alternatively or additionally be used, e.g., gravity, valves, etc. Solar panels 112, or photovoltaic solar panels, can also be included in this example to collect sunlight and convert the sunlight to energy to operate any of the structures that may utilize power, e.g., water pumps, coolant pumps, positive airflow to move the water vapor 120 of the humidified air toward the condensation region or to inflate the enclosed chamber, motors (not shown) for moving sunlight-redirecting optics 114, etc. “Sunlight-redirecting optics” can include, for example, optics that redirect sunlight by changing the angle and/or concentrating sunlight energy using any of a number types of optics, such as mirrors, lenses, assemblies thereof, or combinations thereof. These sunlight-redirecting optics can be similar to those used with concentrating photovoltaic solar panel technology, where solar energy is concentrated towards photovoltaic cells to provide a higher concentration of solar energy. In this instance, the sunlight-redirecting optics are used to send the sunlight energy toward the evaporation panels to generate additional heat for evaporation. The solar panels can provide a way of operating the water purification system off of the power grid, for example, in some instances providing net zero or even negative environmental impact. In this example, a sub-surface cooling portion 162 of a coolant return 160 is shown as being located in a sub-surface cooling region 164 is shown, which can be underground, underwater, etc., but could be at some other location where cooling can occur. Also shown is a purified water line 190 that delivers purified water from a purified water-receiving tank 192, which may be a purified water-receiving tank and/or a secondary purified water-receiving vessel in some examples. The purified water can be used directly from the purified water-receiving vessel, for example, or may be loaded into a water truck 194 for remote delivery.

Within the evaporation region 110 of the enclosed chamber 105, in this example, instead of a single evaporation tower as shown in FIG. 1, there are multiple evaporation towers 200A and 200B. In this example, the evaporation towers are independently configured to receive and increase the surface area of impure water while cascading downward from its upper shelf to lower shelves therebeneath as water evaporates therefrom to form water vapor within the enclosed chamber. Evaporation can be enhanced using a heating source to increase the temperature within the enclosed chamber, and particularly within the evaporation region. By raising the temperature above the ambient temperature (surrounding the enclosed chamber), the humidified air that is generated within the enclosed chamber has a higher water-holding capacity than that of the ambient temperature.

In order for the water purification system to work, the air does not need to be 100% saturated, though in many instances, it may be. For definitional purposes, at 100% relative humidity (R.H.), the air is said to be “saturated,” in that it is holding the maximum amount of moisture possible. The moisture holding capacity of saturated air increases rapidly as temperature increases. For example, the moisture holding capacity of air at 100° F. is about 10 times greater than the moisture holding capacity at 30° F., whereas the moisture holding capacity at 50° F. is about double that at 30° F. To provide some examples, at about 50° F. air holds about 0.0077 pounds of water per 1 pound of dry air (lbs H₂O/lb air), at 70° F. air holds about 0.0158 lbs H₂O/lb air, at 100° F. air holds about 0.044319 lbs H₂O/lb air, at 150° F. air holds more than about 0.2 lbs H₂O/lb air, and at about 188° F. air holds about 1 lb H₂O/lb air. The “dew-point” temperature, on the other hand, is the temperature at which moisture starts to condense from the air at a constant humidity ratio. Surface, such as the surface of the water collectors (not shown, but shown at 150 in FIGS. 1, 19, and 20) at a temperature below the dew point of the air will form condensation thereon. Condensation also occurs in air and results in rain in the outdoors. In accordance with the present disclosure, condensation can occur in the condensation region 140 of the enclosed chamber either by dropping purified (condensed) water from the air, or collecting and running off of the water collectors, for example.

In one example, the heating source used to raise the temperature within the evaporation region (and thus hold more water vapor) can include optics for directing or concentrating sunlight energy within the evaporation region of the enclosed chamber, e.g., through transparent or translucent portions (wall) of the enclosed chamber. As mentioned above, the optics can be a plurality of a series of sunlight-redirecting optics 114 positioned outside of the enclosed chamber which direct the sunlight energy through a transparent or translucent wall of the enclosed chamber and toward the evaporation tower(s). The sunlight-redirecting optics could alternative be within the enclosed chamber, with sunlight passing through the transparent or translucent wall prior to being redirected toward the evaporation tower(s). The sunlight-redirecting optics, or focusing mirrors, can be angled and/or moved along with the sun to extend the daylight time where concentrated solar energy is directed toward the evaporation tower(s). In other examples, the heating source could be a radiant heating source, an IR heating source, a forced air heating source, a flanged heating source, a circulation or inline heating source, a hydrocarbon heating source, a solar heat generating source, or a combination thereof.

Thus, in the example shown in FIGS. 2A-3B, the enclosed chamber 105 includes a chamber wall that partially defines an evaporation region 110 and a condensation region 140. The evaporation region includes chamber walls that may be clear to allow sunlight through, and may also include sunlight-redirecting optics 114, e.g., focusing mirrors, to concentrate sunlight energy, while the condensation region includes chamber walls that are coated to keep the air cooler. As air gets warmer on the evaporation side, the air molecules get larger and have a greater capacity to hold a greater volume and weight of water vapor. With large air molecules having increased water-holding capacity, in some instances, even at these higher temperatures, the humidified air can reach up to 100% relative humidity, or from about 90% to 100% relative humidity. Then, as the water vapor moves to the cooler side, the air molecules shrink and the water drops from the air as purified water formed by condensation. The differential of temperature from the evaporation region relative to the condensation region can be, for example, at least about 20° F., at least about 30° F., or at least about 50° F. Temperature differential ranges can be from about 20° F. to about 140° F., from about 20° F. to about 100° F., from about 30° F. to about 100° F., from about 30° F. to about 80° F., or from about 50° F. to about 140° F., for example. Example temperatures within the evaporation region can be from about 80° F. to about 200° F., from about 100° F. to about 180° F., or from about 110° F. to about 160° F., for example. In one example, the temperature can be from about 130° F. to about 150° F. Example temperatures within the condensation region, particularly at or near (within a few inches) of a condensation assembly 145, can be from about 50° F. to about 100° F., from about 60° F. to about 90° F., from about 60° F. to about 80° F., or from about 60° F. to about 75° F.

Irrespective of these example temperature ranges, maximum temperatures reached for a specific water purification system 100 at or within the enclosed chamber may be as high as desired for a given application. On the other hand, temperatures may be limited by the melting and/or degradation temperature of the equipment used. For example, the evaporation tower(s) 200A and 200B may be constructed from HDPE, which has a melting point around 265° F. and a softening point as low as about 210° F. Thus, a system that utilizes HDPE for the evaporation tower may benefit from keeping a maximum temperature about 10% (or more) below its softening point, e.g., maximum temperature of about 190° F. or so. This maximum temperature could be set to protect the integrity of the evaporation tower(s) in this example. If the temperature were to get too hot relative to the softening point temperature of the HDPE material, impure water from the body of impure water 60 could be cycled more frequently to provide additional cooling to the evaporation tower(s). Alternatively, the sunlight-redirecting optics could be rotated so that they are no longer focused on the evaporation tower(s). For example, the sunlight-redirecting reflectors could be pointed toward the sky or otherwise pointed elsewhere if the enclosed chamber (or any structure therein or thereof) is getting too hot. The same calculation could be carried out for other structures, such as based on the material used to form the enclosed chamber. Temperatures can be kept at a maximum level that protects such structures.

In connection with examples for building evaporation towers in accordance with the present disclosure, some embodiments are provided in FIGS. 4A-18C, but it is understood that other evaporation towers can be used that cascade impure water in a generally downward direction to increase the surface area thereof for evaporation. Evaporation towers can be built in accordance with the technology described in PCT Publication WO 2018/089848, filed on Nov. 10, 2017 and entitled “Evaporation Panels,” which is incorporated herein by reference.

With this in mind, various terminology is used herein as it relates to the evaporation panels, evaporation panel sub-assemblies, evaporation panel assemblies, evaporation towers, and evaporation panel systems described herein. For example, references to terms, such as “horizontal,” “vertical,” “upwardly,” “downwardly,” “upper,” lower,” “top,” bottom,” etc., are generally used relative to the normal operating orientation of the evaporation panels, evaporation panel systems, evaporation panel sub-assemblies, evaporation panel assemblies (single or multiple grouped evaporation panel assemblies), evaporation towers, evaporative separation systems, methods, or the like; or to provide information regarding the spatial relationship between relative features, unless the context indicates otherwise, e.g., such as use of the term “upper” to describe a drawing sheet per se rather than to describe a structure depicted by a FIG. on the drawing sheet. That being stated, some degree of flexibility is intended with respect to absolute orientation or relative relationships. For example, a “horizontal” evaporation shelf may be generally horizontal within a few angular degrees from completely horizontal, or “upwardly facing” may face generally upward, but not necessarily directly upward, etc. In some instances, as an exception where the context may dictate otherwise, minor deviations from absolute orientation or spatial relationships can be specifically described and can thus exclude absolute orientations or spatial relationships, e.g., referring to a lower surface of an evaporation shelf having a slope of from greater than 0° to about 5° would exclude an absolute horizontal lower surface.

The term “laterally” or “lateral” herein generally refers to a side-to-side relationship, and in some limited instances, a front-to-back relationship when defined. For example, when referring to a single evaporation panel, male connectors can be described as being positioned laterally at ends of the evaporation panel (as opposed to a top or a bottom, or a front or back of the panel). Thus, front-to-back (or evaporation panel “depth”) of a single evaporation panel is not considered to be lateral as used herein. On the other hand, when describing the orthogonal (or perpendicular) joining of two evaporation panels, as one evaporation panel has a first orientation and a second evaporation panel has a second perpendicular orientation, this relationship can be described as laterally joining two evaporation panels together, because it results in laterally building out a larger evaporation panel sub-assembly or assembly. More specifically, these two evaporation panels can even more accurately be described as being joined laterally and orthogonally together. Stated another way, when using the terms “laterally” or “lateral,” with respect to a single evaporation panel or an evaporation panel sub-assembly or assembly, there is typically at least one evaporation panel that is being described with respect to an end thereof, such as at a right and/or left end where one or more male connectors are positioned (based on normal operating and upright positioning or orientation, unless the context clearly dictates otherwise). As a further minor point, when referring to an individual feature of an evaporation panel, such as a specific male connector or a specific evaporation fin or a column of evaporation fins, for example, the term “laterally” can be used more generally to describe the feature in any essentially horizontal direction. For example, an evaporation fin can be described as having lateral dimensions along an x-y axes as viewed from above (with the evaporation panel in its upright normal orientation).

When referring generally to one or more “support column(s),” these can be described in two general contexts. A support column, in one example, can be described as spanning the vertical length of the evaporation panel, from the lowermost evaporation shelf to the uppermost evaporation shelf. Thus, the support column can likewise be described as including various support column “sections” between immediately adjacent evaporation shelves. However, in other contexts, a support column, when the context is appropriate, may alternatively refer to the support column section between two immediately adjacent evaporation shelves. In this latter context, the support column typically refers more specifically to the spatial relationship of the support column. For example, a support column may be described as being “between” a first evaporation shelf and a second evaporation shelf. The support column in this example can be understood to be between two immediately adjacent evaporation shelves, or two other evaporation shelves that have one, two, three, four, etc., evaporation shelves therebetween, depending on the context.

The term “releasably join” or “releasably joined,” or even “releasably locked” refers to a mechanical engagement where two (or more) structures (e.g., a structure and an opening defined or bordered by a structure) are joined or snapped together with a locking mechanism, but the locking mechanism can allow for unlocking by an affirmative mechanical action placed on one or both structures, e.g., pinching, pushing, pulling, sliding, lifting, twisting, etc. The mechanical action can include a human finger interaction or can include the use of an unlocking tool of some type, for example. Once two structures are “releasably joined” in place, the two structures should remain together unless a typically intentionally mechanical action occurs. On the other hand, the term “locked” or “un-releasably locked” refers to two (or more) separate structures joined together by a locking mechanism, but they cannot be disjoined without damaging one or more of the structures, or alternatively, by removing a third mechanism (such as a security fastener, e.g., security clip, security pin, etc.) that may be used to convert a joint from being “releasably joined” to “locked.” As an example, a security clip can itself be “releasably joined” with respect to a joint, e.g., a male connector/female receiving opening, but even though it may itself be releasably joined thereto, it can also cause the joint per se to become a “locked” joint. To unlock the joint, the security clip can be removed, and now the joint reverts back to a “releasably joined” joint.

The terms “first, “second,” “third,” etc., are used for convenience and do not infer any relative positioning, nor do these terms need to be used consistently through the entire specification and claims, as they are intended to be relative terms with respect to one another and not absolute with respect to structure. Thus, because these terms are relative to one another, they may be used interchangeably from one example to the next, but are typically used consistently within a single example or within a specific claim set. To illustrate, the use of “first” and “second” in the present disclosure may be used one way describing two relative evaporation panels, and in a different example or in the claims, “first” and “second” terminology may be reassigned. However, within a single example, or a single claim set, the use of the terms “first” and “second” should be used in an internally consistent manner as to that specific example or that specific claim set.

Turning now more specifically to FIGS. 4A and 48, these FIGS. are discussed together as they depict one example evaporation panel 10 taken from multiple views, e.g., a front plan view, left side plan view, top plan view, and bottom plan view as shown in FIG. 4A, as well as a perspective view as shown in FIG. 4B. The evaporation panel in this example can be oriented in an upright position, with a top 12 and a bottom 14 shown. The evaporation panel receives impure water (not shown) generally at or towards the top thereof, but can also be filled from the sides in some examples. Thus, the impure water thinly fills a series of evaporation shelves 16 by receiving the impure water, often toward the top or at the top, and cascading the impure water in a generally downward direction, filling other evaporation shelves positioned therebeneath.

Essentially, a plurality of evaporation shelves can include an upper surface 18 and a lower surface 20 for receiving, holding, and distributing the impure water in a generally downward direction, while exposing a large surface area (air/liquid interface) of the impure water to the natural properties of evaporation, for example. In one specific example, the evaporation shelves can have a flat or essentially flat upper surface with a slight taper over an edge 22 (such as a beveled edge) thereof and a minor slope at the lower surface underneath, e.g., from >0° to 5°, 1° to 4°, 2° to 4°, or about 3° from horizontal. The very slight slope is difficult to see in FIGS. 4A-4B. This configuration provides an arrangement so that once the impure water has overfilled the upper surface, the excess impure water can gently roll over the edge using natural water tension to retain a thin layer of the impure water on the lower surface until full enough to pass the impure water downward to the next lower evaporation shelf. Thus, the lower surface can include this minor or subtle slope as described, but in another example, can be horizontal without slope.

Additional features that can be present on the evaporation panel 10 of FIGS. 4A-4B can include a support column 30. In the example shown, there are sixteen vertical support columns that support twenty-five evaporation shelves 16. The number of support columns and evaporation shelves shown in FIGS. 4A-4B is somewhat arbitrary, as any number of support columns and evaporation shelves can be present, e.g., support columns and/or evaporation shelves can independently number from 2 to 200, from 2 to 100, from 4 to 50, from 8 to 36, from 10 to 24, from 12 to 18, etc. In this example, support columns can include a support beam 32, which in this instance is a center positioned support beam relative to evaporation fins 34. The support beam can be positioned elsewhere, but when in the center, water can fill around the support beam on the evaporation fins, providing more surface area for evaporation.

Though there is a great deal of impure water surface area generated by the multiple evaporation shelves 16, a significant amount of additional surface area can also be provided by the support columns 30 that are used to support and separate the evaporation shelves. For example, when the evaporation panel including the evaporation shelves are filled with impure water, the support columns can also load impure water, providing still more impure water surface area (air/liquid interface) suitable for evaporation.

The evaporation panel 10 can also include structures that are suitable for joining or connecting (and disconnecting) adjacent evaporation panels to form an evaporation panel assembly. In FIGS. 4A-4B, this particular evaporation panel includes a series of male connectors 40 at side or lateral end surfaces of the evaporation panel. The male connectors can be joined orthogonally with other adjacent evaporation panels in any of the many female receiving openings 42 that may be available and configured to join with the male connectors. In this particular example, each and every opening is configured to act as a female receiving opening; however, for practical purposes, when two orthogonal evaporation panels are joined together and both rest on a common horizontal surface, female receiving openings that can be used are in alignment with the location of male connectors of the other (orthogonally oriented) evaporation panel. Other female receiving openings that go unused can act as “open spaces” for providing airflow and/or evaporative venting, for example. That being stated, at open space locations where an evaporation panel may not be intended to join with a male connector, in one example, those specific open spaces may or may not be configured as female receiving openings, but can still act as open spaces for airflow and evaporation purposes.

In further detail, the male connectors 40 on the right side are vertically offset compared to the male connectors on the left side. This is so that two evaporation panels can be aligned and joined along a common vertical plane. If these male connectors were not vertically offset along opposite ends or sides of the evaporation panel, they would not be able to be aligned in this particular configuration, assuming all panels were at rest on a common horizontal planar surface, e.g., the male connectors of two different evaporation panels would occupy the same female receiving opening. On the other hand, if the male connectors were shorter, or if the male connectors were offset with respect to one another but were not necessarily positionally offset with respect to the occupying female receiving opening, they could be configured to occupy a common female receiving opening.

In further detail, evaporation fins 34 found at lateral ends or sides of the evaporation panel (on the support column(s) immediately adjacent to the male connectors) can be smaller in size than other evaporation fins. This is so that the evaporation fins can fit within a female receiving opening of an orthogonally adjacent evaporation panel when two evaporation panels are joined together.

The evaporation panel 10 generally includes a series of vertically stacked, laterally elongated evaporation shelves 16, and a series of vertically oriented support columns 30 positioned periodically along the elongated evaporation shelves which provide support and separation between the series of evaporation shelves. In this configuration, the evaporation shelves and the support columns have the appearance of and provide a “grid structure” with essentially uniformly shaped and aligned rectangular open spaces throughout, and evaporation shelves and support columns defining the grid structure. For definitional purposes, a grid structure such as this, e.g., more than 95% of the area (width by height) is a grid structure with shelves and columns defining the grid with open spaces that are rectangular (or square) defined therebetween, can be more generally described as part of a larger class of structures referred to herein as “grid-like structures.”

Support columns 30 and female receiving openings 42 (or other open spaces), on the other hand, can alternatively be positioned non-periodically or at locations that are not evenly spaced along a length of the evaporation shelves. This configuration includes openings of multiple sizes, some of which are female receiving openings 42 and others of which are not as suitable for joining with a male connector 40, referred to more generically as open spaces 48. Though the male connector can be inserted into these open spaces, because of the larger size of the openings, the male connector may not receive the lateral support otherwise provided at the female receiving openings due to the close proximity of the support column to male connector releasably joined therebetween. That being mentioned, it is noted, however, that “open spaces” can be of any configuration where a male connector is not ultimately joined therein, whether that be an unused female receiving opening or a more dedicated open space not intended to receive a male connector. For definitional purposes, even when the evaporation panel structure includes open spaces of varied lateral size dimensions or widths, the structure still includes vertical columns and horizontal evaporation shelves forming generally rectangular open spaces of different sizes, and thus, this type of structure can be referred to herein as a “grid-like structure,” or more specifically, a “non-periodic horizontally varied grid-like structure.” For that matter, evaporation panel structures that include “grid” or “grid-like” portions along a significant area of the evaporation panel, e.g., at least 50% by area (width by height dimension, excluding depth), can also be considered to be grid-like structures. Likewise, female-receiving openings may be offset horizontally between pairs of adjacent shelves and may still be considered to be “grid-like.”.

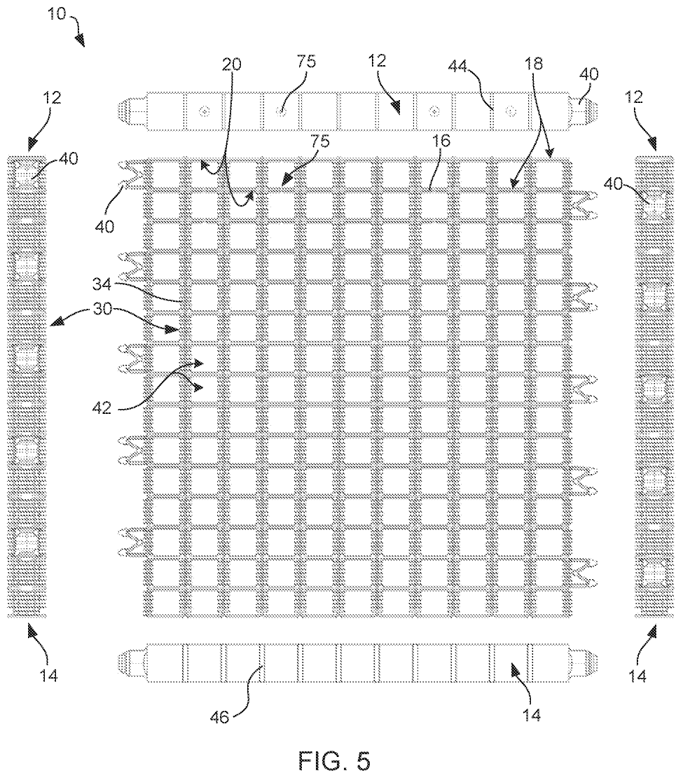

FIG. 5 depicts an alternative example evaporation panel, taken from multiple views, which is similar to that shown in FIGS. 4A-4B. However, the evaporation panel of FIG. 5 includes fewer support columns 30, fewer evaporation shelves 16, fewer male connectors 40, and fewer female receiving openings 42. However, assuming that the evaporation panel has the same relative width and height dimensions as that shown in FIGS. 4A-4B, the open spaces or female receiving openings can be larger and the male connectors can also be correspondingly larger. Furthermore, the spatial relationship or gaps between evaporation fins 34 can be based on the surface tension of water which may be suitable to form a vertical water column (see FIG. 9, for example), and thus the spacing can remain within the range of 0.2 cm to 1 cm, or 0.3 cm to 0.7 cm, or 0.4 cm to 0.6 cm range. As a result, there can be more evaporation fins present between two adjacent evaporation shelves, for example. In this example, for the most part, there are typically seven evaporation fins at the various support column sections (at the bottom, this section of the support column includes six evaporation fins). Furthermore, in one example, the evaporation shelf depth can be about the same or greater than that shown in FIGS. 4A-4B, though any suitable depth can be used that can hold a thin layer of impure water and pass the impure water therebeneath in a cascading manner as described elsewhere herein. This particular evaporation panel also includes pin-receiving openings 75, which can be used in the context of a security feature, locking orthogonally joined evaporation panels together. Other structural features can be as previously described, and need not be re-described in the context of this example.

In accordance with more specific examples, certain impure water flow paths can be generated using the evaporation panels described herein. In one example, when impure water is loaded at an upper surface of an evaporation shelf, the impure water can be transferred to its lower surface (around a tapered or beveled edge in one example) and to additional “upper surfaces” on evaporation shelves positioned therebeneath. Some of the impure water can also be transferred to the evaporation fins, for example, and then passed down to the next evaporation shelf. Thus, as water is evaporated from the impure water at various upper surfaces and evaporation fins, a more concentrated impure water can move downward along the evaporation panel. This can lead to a cascading of impure water in a generally downward direction where the evaporation removes or reduces water content and the contaminants or other material in the impure water become more concentrated, or alternatively the water becomes cooled in evaporative cooling examples. The evaporation shelves can be stacked in any number within a single evaporation panel, e.g., from 2 to 200 evaporation shelves, from 4 to 50 evaporation shelves, from 8 to 24 shelves, etc. The evaporation shelves can thus be vertically stacked and spaced apart with horizontal evaporation fins positioned therebetween. In one example, the evaporation panel can include at least four evaporation shelves and at least four support columns between each pair of evaporation shelves. This particular evaporation panel can also include at least nine open spaces, some of which can act as female receiving openings for receiving one or more male connectors from an adjacently orthogonally positioned evaporation panel.

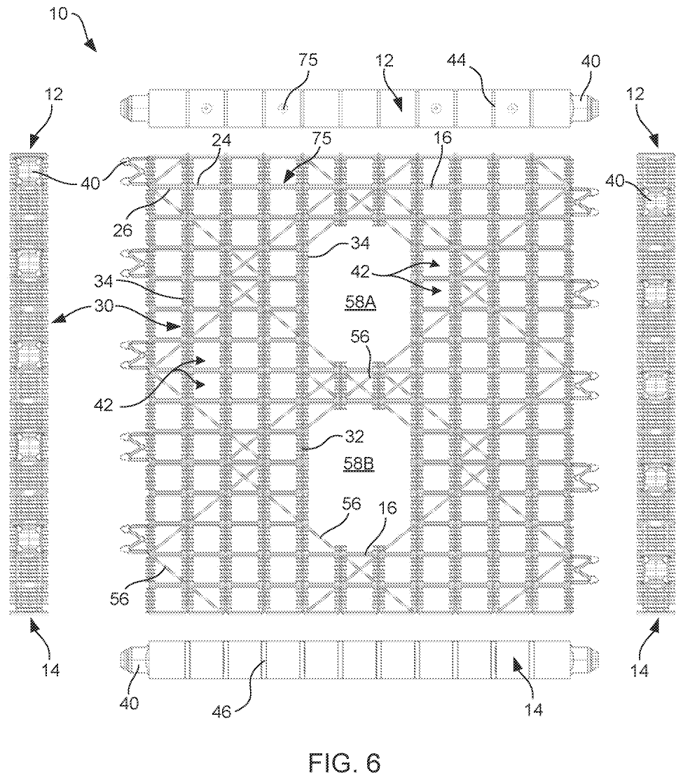

Turning now to FIG. 6, an alternative example evaporation panel 10 is shown taken from multiple views. In this example, the evaporation panel includes all of the same types of features shown in FIGS. 4A-5, but in this example, includes two additional features, namely enlarged evaporative airflow channels 58A and 58B and cross supports 56. The other reference numerals are the same as previously described. By including evaporation panels with an enlarged airflow channel or multiple enlarged airflow channels as part of a large evaporation panel assembly or evaporation tower, a large volume of airflow and/or water vapor clearing from the assembly can occur without sacrificing significant weight bearing properties or weight compression resistance, e.g., strength of the evaporation panel assembly that prevents an impure water-loaded evaporation panel assembly (or tower) from crushing lower levels due to the weight applied thereon. The enlarged evaporative airflow channels provide enlarged horizontal airflow paths that can assist in moving air in and out and water vapor out of the evaporation panel assemblies, particularly when the evaporation panel assembly is large (e.g., in both footprint and height), and the center of the evaporation panel assembly has difficulty clearing moisture therefrom.

With these enlarged evaporative airflow channels 58A and 58B, when they are positioned in alignment with respect to horizontal airflow through an evaporation tower, they can allow for airflow/evaporation to and from evaporation panel to evaporation panel, from outside of the evaporation panel assembly to within the evaporation panel assembly. These enlarged airflow patterns can also be extended by aligning the (already aligned) enlarged evaporative airflow channels coupled with enlarged inter-panel spaces (see 39 at FIG. 14B) kept open between parallel panels. In one example, when positioning panels orthogonally with respect to an evaporation panel that includes enlarged evaporative airflow channels, the orthogonally oriented evaporation panels can be positioned just laterally (one on each side) with respect to the enlarged evaporative airflow channels so as to not obscure the enlarged evaporative airflow channel opening.

In further detail with respect to FIGS. 5-6, many of the same structures shown and described using reference numerals with respect to FIGS. 4A-4B are relevant to these alternative embodiments. For example, these evaporation panels 10 are shown oriented in an upright position with a top 12 and a bottom 14. The evaporation panel receives impure water (not shown) generally at or towards the top thereof, but can also be filled from the sides as well in some examples. Thus, impure water can thinly fill a series of evaporation shelves 16 by receiving the impure water toward the top and cascading the impure water in a downward direction, filling other evaporation shelves positioned therebeneath. Essentially, a plurality of evaporation shelves can include an upper surface 18 and a lower surface 20 for receiving, holding, and distributing the impure water in a generally downward direction, while exposing a large surface area (air/liquid interface) of the impure water to the natural forces of evaporation, for example. In one specific example, the evaporation shelves can have a flat or essentially flat upper surface with a slight taper over an edge 22 (such as a beveled edge) thereof and a minor slope at the lower surface underneath, e.g., from >0° to 5°, 1° to 4°, 2° to 4°, or about 3° from horizontal, or can alternatively be essentially horizontal. Additional features that can be present include support columns 30 which support the evaporation shelves. The number of support columns and evaporation shelves is somewhat arbitrary, as any number of support columns and evaporation shelves can be present, as previously described. In this example, support columns can include a support beam 32, which in this instance is a center positioned support beam, and evaporation fins 34. The support beam can be positioned elsewhere, but when in the center, water can fill around the support beam on the evaporation fins. In this example, the evaporation fins are positioned around the enlarged evaporative airflow channels 58A and 58B in order to provide increased surface area to impure water loaded on those particular evaporation fins. However, in other examples, the evaporation fins might not be present around the enlarged evaporation airflow channels.

The evaporation panels 10 can also include structures that are suitable for joining (releasably joining) adjacent evaporation panels from a common evaporation panel system to form an evaporation panel assembly. This particular evaporation panel includes a series of male connectors 40 at sides or ends (positioned laterally at ends when viewing the evaporation panel from the front) of the evaporation panel. The male connectors can be joined orthogonally with other adjacent evaporation panels in any of the many female receiving openings 42 that may be available. In this example, the female receiving openings can also act as open spaces (most of which being available for airflow as many may not specifically be associated with a corresponding male connector) to facilitate airflow through the evaporation panel. As with the evaporation panels previously shown, the male connectors on the right side can be vertically offset with respect to the male connectors on the left side. This is so that two evaporation panels can be joined in a common line (with an orthogonally positioned third evaporation panel positioned therebetween). If these male connectors were not vertically offset along the lateral sides or ends of the evaporation panel, they would not be able to align in this particular configuration, e.g., the male connectors would occupy the same female receiving opening. That being stated, as with any of the other examples, if the male connectors were shorter so that they did not interfere with one another, or if the male connectors were otherwise offset with respect to one another, but were not necessarily positionally offset in separate female receiving openings, they could be configured to occupy the common female receiving opening (e.g., two male connectors that would “face” one another or pass along-side of one another for positioning within a common female receiving opening could be offset within the female receiving opening or could be otherwise shaped to not interfere with one another). In further detail, the evaporation fins 34 found at the lateral ends or sides of the evaporation panel (at the support column(s) immediately adjacent to the vertically aligned male connectors) can be smaller in size than other evaporation fins. This is so that the evaporation fins could still provide some impure water-holding and evaporative function, while still being able to fit within a female receiving opening of an orthogonally adjacent evaporation panel when two evaporation panels are releasably joined or locked together.

In further detail, to facilitate evaporation, adjacent evaporation shelves can vertically define and border a plurality of open spaces within the evaporation panel, and adjacent support columns can horizontally define and border the plurality of open spaces as well. Thus, to promote evaporation of the impure water from the waste material contained therein, airflow through these open spaces can occur, as previously described, e.g., including generic open spaces 48 or female receiving openings 42 that may not be used for receiving male connectors 40. In further detail, evaporative fins 34 of the vertical support column 30 (when loaded with a column of impure water, for example) can generally define and border enlarged evaporative airflow channel 58A having a channel area that can be at least eight (8) times larger than an average area of the individual open spaces, e.g., 8 to 80 times larger, 10 to 60 times larger, 10 to 40 times larger, 20 to 40 times larger, etc. In one example, a second enlarged evaporative airflow channel 58B having a channel area at least eight (8) times larger than the average area of the open spaces can also be present, e.g., 8 to 80 times larger, 10 to 60 times larger, 10 to 40 times larger, 20 to 40 times larger, etc. In one example, one of the enlarged evaporative airflow channels can be larger than the other, or in still another example, the two airflow channels can be about the same size.

For further clarity with respect to the examples shown in FIG. 6, when comparing the channel area size of a single enlarged evaporation airflow channel, 58A or 58B, to the area size of smaller “open spaces,” the open space area size is based on an average area size, whereas the enlarged evaporation airflow channel 58A area size is based on an individual channel area size, not the collective area size of all enlarged evaporative airflow channels. Furthermore, the respective relative area sizes (for size comparison) can be measured essentially as a perpendicular plane relative to the generally horizontal airflow pattern that can occur into and out of the evaporation panel's various types of airflow openings. In other words, the respective areas can be measured using the horizontal and vertical axes of the evaporation panel when viewed from a front plan perspective view. Additionally, the calculated respective area sizes do not include any of the small inter-fin spaces or gaps found vertically between the evaporation fins, as when loaded with impure water, these gaps typically can be filled with water, as shown in FIG. 9-10. Thus, the area is based on the area when loaded with wastewater for simplicity. These calculations can also ignore any de minimis positive structure that may complicate the average area size calculation, such as the cross-supports 56. Also, for further clarity, evaporation panel “depth” (front to back dimension as viewed from the front plan perspective) is not used when calculating the relative area sizes of the open spaces, as a volume measurement is not relevant to this particular ratio calculation. In still further detail, the term “enlarged” in the context of the enlarged evaporation airflow channel (as well as the enlarged inter-panel space) is a relative term, meaning that each evaporative airflow channel is enlarged relative to the average size of the open spaces (or relative to the other inter-panel spaces), which again can be an average area provided by both used and unused female receiving openings 42, as well as any other open spaces that may be present. That being mentioned, these and other types of open spaces should have an area size that is within the range of four times larger to four times smaller than the female receiving openings to be included in the open space average size calculation. If much larger than this, these other types of open spaces would begin to approach the size of an individual enlarged evaporation airflow channel.

As a specific example regarding the area size ratio of the average area size of the open spaces compared to the absolute area size of a single enlarged evaporative airflow channel, the ratio of the average area size of the open spaces (all of which are female receiving openings in this example, ignoring gap spaces between evaporation fins, and ignoring the positive structure of the cross-supports that fall within the open spaces) to the average area size of enlarged evaporation airflow channel 58A can be about 1:30 (e.g., just under 30 times larger). In further detail, the ratio of the average area size of the open spaces to the absolute area size of enlarged evaporation airflow channel 58B is about 1:35 (just under about 35 times larger). Thus, these enlarged evaporation airflow channels are both within the range of “at least eight (8) times larger” compared to the average area size of the open spaces. More specific suitable area size ratio ranges can be, for example, from 1:8 to 1:80, from 1:10 to 1:60, from 1:10 to 1:40, from 1:20 to 1:40, etc.

Turning now to some of the functional features of the evaporation panels described herein, for purposes of further showing and describing both the shape and configuration of a water column that can be formed, as well as airflow patterns that the water columns can influence, FIGS. 7-10 provide some detail of a portion of an evaporation panel 10 shaped and configured in accordance with examples of the present disclosure. FIG. 7 shows a similar structure to that shown as evaporation panel 10B in FIG. 7. For example, the evaporation panel can include a top 12 and bottom 14 (not shown) evaporation shelves 16, each with an upper surface 18 and a lower surface 20 in this example. The evaporation panels can also include upwardly extending ridges 24 and downwardly extending ridges 26, as well as male connectors 40 and female receiving openings 42 (and open spaces that may not be used for joining, but which can provide airflow therethrough). The panels can also include support columns 30 including support beams 32 and evaporation fins 34, as previously described. These support columns and evaporation shelves are arranged as a grid-structure, but could be any other grid-like structure described herein.

In further detail, FIG. 8 depicts a top cross-sectional and partial plan view of section A-A of FIG. 7. Thus, FIG. 8 shows a cross-sectional view of the support beam 32, as well as an overhead top plan view of the evaporation fin 34, an upper surface 18 of an evaporation shelf, and upwardly extending ridge 24 of the evaporation shelf. In this example, the general lateral shape (when viewed from above) of a periphery of the evaporation fin can be similar to that of a perpendicular cross-sectional shape of an airfoil, which in this example, may be a symmetrical laminar airfoil. By way of definition, the “perpendicular cross-sectional” shape of an airfoil is generally taken vertically from front to back with respect to a horizontally positioned airfoil, e.g., a horizontal wing orientation. In other words, the perpendicular cross-sectional view refers to the general front to back (such as on an airplane) vertical cross-sectional shape of the airfoil, which would include the leading edge and the trailing edge taken perpendicularly with respect to the orientation of the horizontal airfoil wing. In further detail, this particular shape can provide certain advantages with respect to water evaporation and airflow in accordance with examples of the present disclosure. For example, this airfoil shape can enhance water retention, and can allow air to pass through the openings (past the evaporation fins and water retained thereon) like a vertically oriented wing, thereby improving evaporation because of enhanced airflow dynamics, as will be discussed in further detail hereinafter. There are various dimensions that can be used to form the airfoil shape (or any other generally elongated shape). For example, the depth of the evaporation fin can be approximately the same or the same as a depth of the evaporation shelf, e.g., 1.5 inch, 2 inches, 3 inches, etc. The width can be less than a length of the depth, thus providing an elongated shape in the direction of its depth (front-to-back; or elongated in an orthogonal direction relative to the laterally elongated orientation of the evaporation shelves). Example ratios of depth (front-to-back dimension) to width (side-to-side dimension) can be, for example from 6:1 to 8:5 or from 4:1 to 2:1.

Turning now to FIG. 9, a close-up view of a still smaller portion of an evaporation panel 10 is shown, and approximates the small section encompassed by dashed lines in FIG. 7. This view includes and shows impure water 50 loaded on the evaporation panel. Also shown is an air/liquid interface 52, which in this instance is an interface where the air interfaces with impure water, e.g., impure water which includes water and secondary material to be separated from the water. Even though there is a great deal of impure water surface area generated by the multiple evaporation shelves 16, still more impure water surface area (at the air/liquid interface) can also be provided by the support columns 30 that are used to support and provide separation to the evaporation shelves. As previously mentioned, the support columns can include a support beam 32 and evaporation fins 34. Thus, for example, when the evaporation panel, including the evaporation shelves, is filled with impure water, the support columns can also be loaded with impure water, providing still more impure water surface area suitable for evaporation. In one example, due to the spacing between the evaporation shelves and the evaporation fins, and/or due to the spacing between the evaporation fins to one another, the surface tension of the water can be used to form a vertical water column 54 along a length of various support column sections found between pairs of evaporation shelves. Example spacing can be from 0.3 cm to 0.7 cm, but this range is not intended to be limiting. The nature of the impure water and the material (and surface treatment) used to form the evaporation fins can lead to modifying this range, such as from 0.2 cm to 0.6 cm, or from 0.4 cm to 0.8 cm. More generally, from 0.2 cm to 1 cm provides a reasonable working range for evaporation fin spacing in some examples. Furthermore, the water column is shown generally in this FIG. as providing a straight columnar air/liquid interface. However, this is shown in this way for convenience and to clearly show how a water column is formed. Depending on the water content loaded thereon, as well as the respective surface tension and surface energy properties of the impure water and panel surface, there may be more (bulging) or less (recessing) water relative to the evaporation fins at the air/liquid interface compared to that shown in FIG. 9. Additionally, at locations where the water column interfaces with the evaporation shelves (particularly the bottom), there may be some vertical to horizontal curving along the air/liquid interface that can occur that is not shown in a pronounced manner in this FIG. Suffice it to say, the water column shown herein provides an example of impure water loaded on or at evaporation fins of a support column.

In one example, as the impure water cascades from an evaporation shelf upper surface 18, around an edge 22 (such as a beveled edge) and onto a lower (downward facing) surface 20 thereof, a portion of the impure water can be passed directly from the lower surface to the next evaporation shelf (therebeneath), and another portion can be passed to the vertical water column supported by the presence and configuration of the evaporation fins of the support column, and so forth. An upwardly extending ridge 24 can be present on the upper surface to prevent pooling at a center of the evaporation shelf and to guide the impure water toward the edge rather than toward the end. This ridge can also provide wind resistance, preventing impure water from being blown from the upper surface as well as holding impure water in place in situations where the panel may be slightly tilted due to wind, for example. The downwardly extending ridge 26 can be present to facilitate downwardly cascading impure water from one evaporation shelf to the next, either directly or as a guide toward the support column.

In further detail, to form the vertical water column 54, spacing between the evaporation fins 34 as well as material choice can be considered in order to take advantage of the surface tension of impure water. For example, the evaporation fins can be spaced apart at from 0.2 cm to 1 cm, but more typically from 0.3 cm to 0.7 cm, or from 0.4 cm to 0.6 cm. Likewise, the uppermost evaporation fin can be similarly spaced from a lower surface 20 of the evaporation shelf that is positioned thereabove. The lowermost evaporation fin can be likewise similarly spaced from an upper surface 18 of the evaporation shelf that is positioned therebeneath. In further detail, the support column 30 can include a support beam 32, such as a centrally positioned support beam, and the evaporation fins can extend outward from the support beam (on average) at from 0.2 cm to 1 cm, but more typically from 0.3 cm to 0.7 cm, or from 0.4 cm to 0.8 cm. These dimensions are provided by way of example only, and other dimensions can be selected based on the material choice, the type of impure water, the desired flow rate of the impure water, etc.

As shown in FIG. 10, a top cross-sectional and plan view taken along section B-B of FIG. 9 is shown. The structures shown in this FIG. are similar to that show in FIG. 8, but in addition, details are provided related to the retention of impure water 50 at the various surfaces, including along a vertical water column 54. Additional details regarding possible airflow 38 around the airfoil-shaped vertical water column that can be formed is also shown. Thus, FIG. 10 again includes a cross-sectional view of the support beam 32, and an overhead top plan view of the evaporation fin 34 as well as an upper surface 18 and upwardly extending ridge 24 of an evaporation shelf. As can be seen from this view, the impure water is loaded on both the evaporation fin and the upper surface of an evaporation shelf. The upwardly extending ridge 24 is not loaded with impure water in this example, and can act to guide the water away from the center of the evaporation shelf, prevent pooling, provide impure water wind resistance, etc. Again, along an edge of the evaporation fin, a vertical water column (in cross-section) is shown which comprises a portion of the impure water.

In further detail, FIG. 10 also shows the general shape of an evaporation fin 34, which in this example, has the cross-sectional shape of a symmetrical laminar flow airfoil taken vertically from leading edge to trailing edge based on a horizontally oriented airfoil. Thus, the evaporation fins are shaped and spaced apart as a guide so that when impure water is loaded thereon, the evaporation fins provide a framework to form the vertical water column 54 having the shape of an airfoil, and in this particular instance, a symmetrical laminar flow airfoil. Other shapes can be used, and in some examples, other airfoil shapes can be used, but the symmetrical laminar flow air foil shape provides acceptable bi-directional airflow properties. The airfoil shape in this example includes a leading edge 36 that directs airflow 38 around the vertical water column, once formed. Furthermore, because the vertical water column is shaped like a symmetrical laminar flow airfoil, if the airflow were to be in the opposite direction, then the leading edge would be found on the opposite side of the vertical water column. This allows for efficient airflow across the vertical water column in multiple directions, depending on the orientation of the evaporation panel and air currents that may be present. Stated another way, appropriately spaced and stacked evaporation fins can hold water vertically, and the vertical water column can act as an airfoil because of the guiding shape and spacing of the evaporation fins. For clarity, the evaporation fin is not the airfoil per se, but rather the evaporation fins are stacked and shaped to form a vertical water column that, when loaded with impure water, becomes shaped like a symmetrical laminar flow airfoil that is vertically oriented in this particular example. In further detail, the airfoil shape can also assist in facilitating evaporation of the water by efficiently promoting airflow, like a wing, around the vertical water column during evaporation.

In further detail, during evaporation (particularly when a more complex evaporation panel assembly is formed such as that shown FIGS. 14B-16, or when the structure is much more complex), evaporation within the structure can promote cooling compared to higher temperatures that may be present outside of the structure. The differential in these temperatures (cooling during evaporation vs. hot and/or dry conditions outside of the evaporation panel assembly) can promote the generation of natural airflow patterns within the evaporation panel assembly. Thus, as shown in FIG. 7, female receiving openings 42 (some of which can be used to connect with a male connector 40 as previously described and some of which remain open spaces for facilitating airflow) can be defined laterally between adjacent support column sections and vertically between adjacent evaporation shelves to provide openings for airflow and water vapor venting to occur around the airfoil shaped vertical water column. This configuration, along with the cooling associated with evaporation, can generate natural airflow across any of the respective water surfaces using natural drafts induced by temperature differential for enhanced evaporation speeds. In other words, the open spaces through each of the panels, the inter-panel spaces between parallel evaporation panels, and/or the vertical water columns (shaped like an airfoil in this example), along with the natural drafts induced by evaporation and temperature differentials, can generate enhanced evaporation speeds, even without an external forced airflow source, e.g., fans, natural wind, etc. The use of fans, heat, or other man-made evaporative conditions can be used, but in many instances, they are not needed because of the design features described herein. Thus, the evaporation panel systems and assemblies of the present disclosure can be used with or without external forced airflow sources, and/or with or without artificially elevated temperatures. Natural airflow currents induced by the temperature differentials and/or natural wind, for example, can be used to provide the airflow for the evaporative process to efficiently occur. Thus, the shape of the shelves and/or evaporation fins can be aerodynamically designed, including as designed in embodiments described herein, to allow enhanced airflow across the shelf. Thus, in some instances, the shape of these structures can cause the airflow to speed up as it moves through one evaporation panel to the next evaporation panel, rather than getting bogged down and becoming stagnant as a result of the effects of wall interference (wall effect). In other words, the aerodynamic shape of the evaporation fins as well as the evaporation shelves (when loaded with the impure water) provides the benefit of moving air through the evaporation panel assembly more rapidly, and/or moving air generally from top to bottom in some instances.

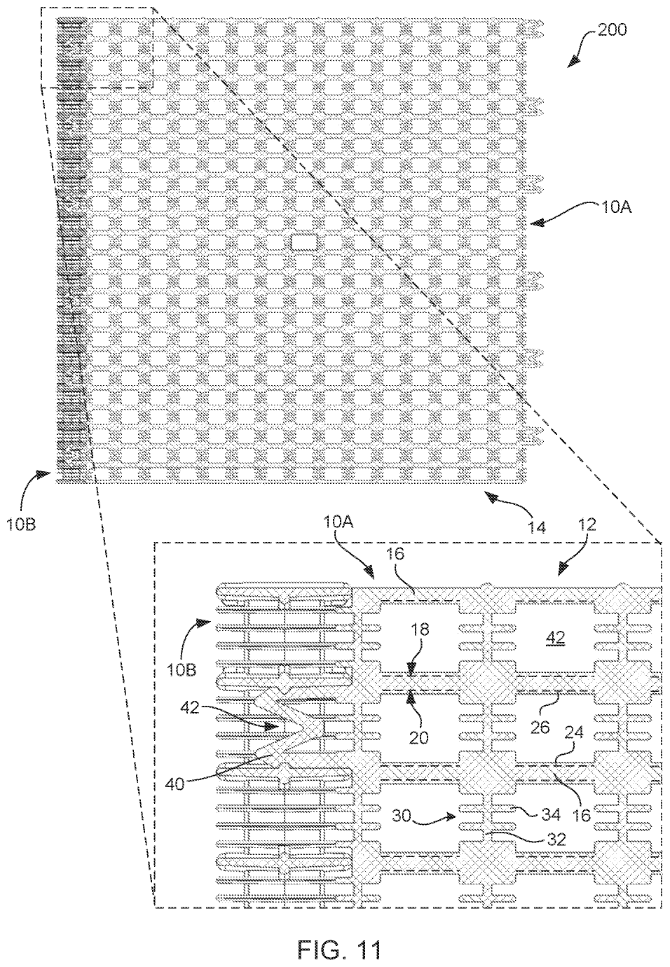

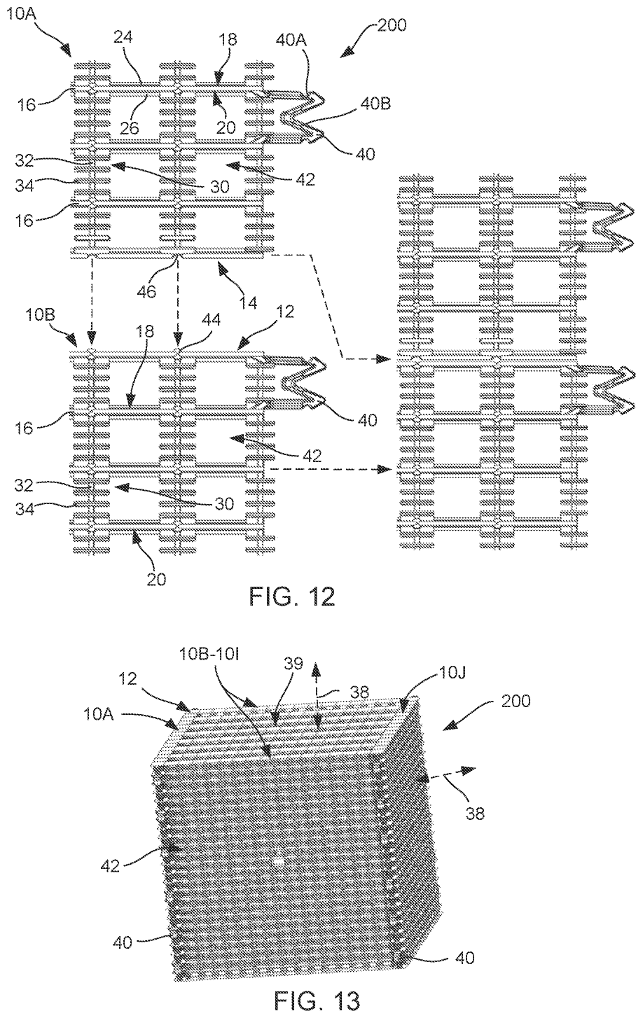

FIGS. 11 and 12 depict an example of an evaporation panel system or evaporation towers 200 (also referred to as an evaporation panel assembly once assembled), including a first evaporation panel 10A and a second evaporation panel 10B. In this example, both evaporation panels of the system can include many similar features as that described in FIGS. 4A-6. Specifically in FIG. 11, the first evaporation panel is connected orthogonally with the second evaporation panel. In FIG. 12, the first evaporation panel is positioned on top of the second evaporation panel. When building an evaporation panel assembly, typically, both orthogonal connection and vertical stacking can occur to form an evaporation tower, for example. The individual evaporation panels can include a top 12 and a bottom 14. Evaporation panel relative “tops” and “bottoms” are also shown in FIG. 12 after being stacked. The evaporation panels also include evaporation shelves 16, each with an upper surface 18 and a lower surface 20 in this example. The evaporation panels can also include upwardly extending ridges 24 and downwardly extending ridges 26, as well as male connectors 40 and open spaces which can be configured as female receiving openings 42. With respect to the male connectors particularly shown in FIG. 12 in further detail, the male connectors can include male connector engagement grooves 40A on the top and bottom thereof (relative to the upright and standing operational position of the evaporation panel) for engaging with downwardly extending ridges and upwardly extending ridges, respectively, when joined orthogonally with female receiving openings of adjacent evaporation panels. Also shown is a male connector locking channel 40B, which in one example can be used to form a locking engagement with a security clip (not shown), thus converting the male connector and female receiving opening connection from a releasably joined coupling to a locked coupling.

The evaporation panels (10A and 10B) can also include support columns 30 including support beams 32 and evaporation fins 34, as previously described. Notably, when the evaporation panels are joined together, the bottom of evaporation panel 10A can be placed or stacked on the top of evaporation panel 10B. To prevent movement or slippage when in place, the top of the second (lower) evaporation panel can include coupling ridges 44 and can be paired with the bottom of the first (upper) evaporation panel, which can include corresponding coupling grooves 46. When the first and second evaporation panels are joined at the bottom and top surfaces, respectively, the lowermost shelf of evaporation panel 10A and the uppermost shelf of evaporation panel 10B become unified to form a “single” evaporation shelf, shown generally at panel interface 13 in FIG. 12. In this configuration, the first evaporation panel can either rest on the second evaporation panel (as shown in FIG. 12), or the evaporation panels can be clipped together to prevent shifting movement using security clips. In accordance with a further detail, in this example, the evaporation fins that are shown at a lateral end or ends of the evaporation panel can be slightly smaller than the evaporation fins present elsewhere on the evaporation panel. In this example, this size difference is provided so the evaporation fins are small enough to fit within the female receiving openings of an adjacent evaporation panel that may be joined laterally and orthogonally therewith. That being stated, in other examples, the evaporation fins can be the same, smaller size along the entire evaporation panel, or the evaporation panel can be configured so that there are no evaporation fins at lateral ends of the evaporation panel to avoid interference when orthogonally joining two evaporation panels.

The evaporation panel system or assembly shown in FIG. 11 shows laterally joined orthogonally oriented evaporation panels (which is an L-shaped sub-assembly), and the evaporation panel system or assembly shown in FIG. 12 shows vertically stacked evaporation panels. Thus, the evaporation panel systems or assemblies shown in FIGS. 11-12 can be combined to form more complex evaporation panel assembly structures, e.g., laterally joined and vertically stacked. For example, a more complicated laterally joined evaporation panel system can be formed using many evaporation panels, and these more complicated laterally joined evaporation panel systems can be stacked vertically. As one might appreciate after considering the present disclosure, very complicated structures the size of large buildings with rooms, hallways, stairs, walls, open channels, etc., can be formed by laterally joining evaporation panels in an orthogonal orientation (in an X-Y direction or axes viewed from above) to form a level of joined evaporation panels, and evaporation panels (levels) can likewise be joined together and stacked as high as reasonable (in a Z direction or axis viewed from above). Thus, by adjoining evaporation panels laterally, and in many instances, stacking vertically, three-dimensional larger structures, including very complicated and or large structures, can be assembled. In one example, the assemblies can be put together without the need or use of special tools since the male connectors can be snapped into female receiving openings, and further, because evaporation panels can likewise be stacked vertically by incrementally laterally building out additional levels on top of previously laterally joined levels, as shown and described herein. In some examples, however, when the use of tools would be advantageous, such as the use of a mallet to join panels, or the use of a leveraging tool to disconnect evaporation panels (or security clips described hereinafter), such tool can be used.

When referring to “assemblies,” or “sub-assemblies,” or when describing the “assembly” of evaporation panels into sub-assemblies or evaporation towers, etc., it is understood that the assemblies can likewise be disassembled. Thus, the evaporation panels described herein can be part of a modular system that can be assembled, such as on-site at an oil drilling or processing site or at a mining site, etc., and then can be disassembled and stacked for future use or transported away from the site, such as for disposal, recycling, or in many instances, for reuse (reassembly) at another site.

Turning now to FIG. 13, a perspective view of ten evaporation panels joined laterally to one another to form a cube-shaped configuration is shown. Specifically, a first evaporation panel 10A has a first orientation, and a tenth evaporation panel 10J has a parallel orientation with respect to evaporation panel 10A. Evaporation panels 10B-101 are positioned between and orthogonally oriented with respect to evaporation panels 10A and 10J. A single panel space (or one position) is left between or remains unused between adjacent evaporation panels 10B-101 to allow for airflow 38 as well as allowing space for evaporative water vapor to become vented therefrom, such as through any of a number of inter-panel spaces 39. Airflow and evaporative venting can also be provided by female receiving openings (or open spaces/voids) that are not otherwise occupied by a male connector. Assembly spacing between panels in conjunction with panel openings can drive airflow across surfaces using natural drafts induced by temperature differential (e.g., evaporation cooling inside vs. ambient temperature outside of the evaporation panel assembly) for enhanced evaporation speeds.

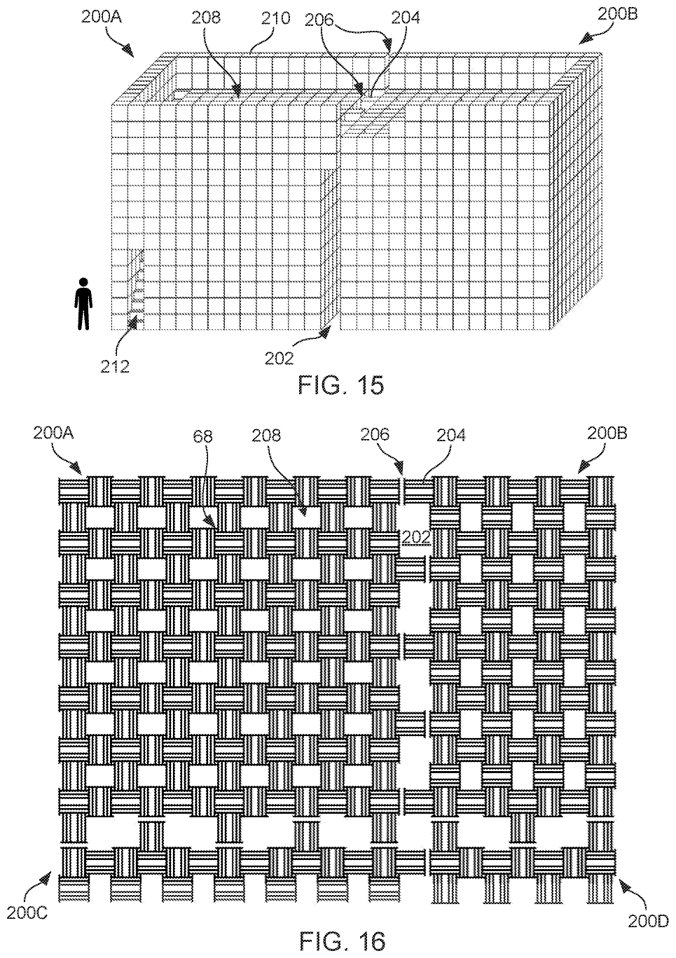

It is noteworthy that the “cube” configuration shown in FIG. 13 is one example of a basic unit structure or sub-assembly that can be used repeatedly to form much larger and more complex evaporation panel assembly structures. For example, many cubes can be formed which are laterally locked together and vertically stacked to form larger evaporation panel assemblies in the form of large structures, towers, etc., which can include stairs, walls, platforms, bridges, etc. formed using evaporation panels, such as that shown in FIGS. 15-16 hereinafter. As a further note, the cube-shaped configuration shown in FIG. 13 when used as a building block to laterally form larger structures can “share” common evaporation panels with adjacently positioned “cubes.” For example, the first or tenth evaporation panel 10A or 10J of the cube in FIG. 13, or the second or ninth evaporation panel 10B or 101 of the cube of FIG. 13 may function as the first evaporation panel for an adjacent “cube” assembly. Thus, the term “cube” can be defined to include general cube-like structures (such as comb-shaped sub-assemblies), even if that structure shares one or more evaporation panels with an adjacently positioned “cube.”

With this example in mind, the term “unit structure” or “sub-assembly” can be used to refer to any basic evaporation panel configuration that can be used repetitiously or semi-repetitiously to be joined together (sometimes with other types of sub-assembly shapes or other configurations of sub-assembly shapes of the same type) to laterally build out more complex evaporation panel assemblies. Sub-assemblies refer to laterally joined evaporation panels, and not vertically stacked evaporation panels. Furthermore, “sub-assemblies” are basic units of any number of orthogonally joined evaporation panels that can generally be about one panel wide by about one panel deep by one panel high, e.g., 1×1×1 panel dimension. Thus, any configuration that is the size of about a 1×1×1 panel can be considered a “sub-assembly” in accordance with examples of the present disclosure. Notably, the dimensional relationship of 1×1×1 does not infer an absolute relational dimension, but rather, only relative dimensional ratios consistent with the manner in which the evaporation panels join together orthogonally. For example, evaporation panels that are two feet wide, two feet tall, and two inches deep can be used to form an essentially 2 cubic foot sub-assembly. That being stated, the exact relational dimension of each sub-assembly may not be an exact 1×1×1 dimension (or 1:1:1 size ratio), as when panels are joined orthogonally, the depth of one or two evaporation panels can add to the width of an orthogonally oriented evaporation panel. For example, if a panel is two feet wide by two feet tall by two inches deep, a 1×1×1 sub-assembly may be two feet four inches wide, two feet tall, and two feet deep (assuming two evaporation panels are oriented in parallel with one or more intervening evaporation panel(s) orthogonally positioned therebetween); or the sub-assembly may be two feet two inches wide, two feet tall, and two feet deep (if there is only one evaporation panel in one “end” or “spine” evaporation panel in one of the two orthogonal orientations relative to parallel “teeth” evaporation panels). These configurations would still be considered to be a “sub-assembly” in accordance with examples of the present disclosure. Thus, for definitional purposes, a 1×1×1 evaporation panel sub-assembly, or a 1:1:1 evaporation panel sub-assembly size ratio includes the addition of relative depths of “end” or “spine” evaporation panels, which will be defined in further detail hereafter.

In some examples, there may be two or more types of sub-assemblies or unit structures that can be formed that may be used to build out more complex evaporation assemblies in a repetitive or semi-repetitive manner. Thus, a “cube” is but one example of such a unit structure or sub-assembly. A cube may, for example, be joined with (another) comb-shaped sub assembly to form two adjacent cubes which share a common joining evaporation panel. Furthermore, other unit structures or sub-assemblies can be joined with other sub-assemblies to build more complex evaporation panel assemblies, and such sub-assemblies can include the following: L-shaped, T-shaped, comb-shaped (e.g., U-shaped, E-shaped, cube-shaped, etc.), pi-shaped, asymmetrical shapes thereof, etc. Some of these example configurations are shown in FIG. 14A, each of which depicts a top 12 view of nine example sub-assemblies. There are, of course, other possible sub-assemblies that can be formed, but these nine embodiments illustrate various example configurations or shapes, including variants thereof, which are intended to help with understanding each type of sub-assembly. The sub-assemblies shown in FIG. 14A (and larger assemblies shown in FIGS. 14B-C) are illustrated from an upper or top plan view for clarity, as it is from this view that the shape of the sub-assembly can be best viewed. From this view, an upper surface, or top, of an uppermost evaporation shelf is shown, which can include coupling ridges 44. The upper surface can be used for vertically stacking additional evaporation panels thereon, and the coupling ridges can be used to engage with coupling grooves (not shown) on a bottom (not shown) of the next level of evaporation panel sub-assemblies or assemblies. In these examples, though coupling ridges are not required, they are conveniently positioned so that from this upper plan view, an approximate location of vertical support columns can be understood, e.g., directly beneath the coupling ridges. Likewise, vertically aligned female receiving openings can be understood and visualized as being vertically aligned generally below the areas between adjacent coupling ridges. That being mentioned, the support columns need not align with the coupling ridges, and any of a number of relative evaporation panel sizes, configurations, etc., can be used to form sub-assemblies as described herein. For purposes of the simplicity and clarity of discussion, however, the evaporation panels shown in FIGS. 14A-C generally have an example configuration similar to that shown in FIGS. 4A-4B, without any particular limitation implied thereby, but could be formed of other evaporation panels of other configurations. Male connectors 40 are also shown and can be seen from these nine top plan sub-assembly views of FIG. 14A. Again, these structures are viewed from above. Female receiving openings, evaporation shelves (other than the topmost shelf), support columns, evaporation fins, etc., are not shown, as they are obscured by the top of each evaporation panel.

The shapes described herein with respect to the various sub-assemblies are based on a top plan view of assembled evaporation panels. For brevity and to avoid overly complicated descriptions of the various sub-assemblies that can be used to form more complex evaporation panel assemblies, e.g., towers, in describing the various sub-assembly shapes below in further detail, the term “panel” may be used generally rather than the longer term “evaporation panel.” Furthermore, for each of these sub-assemblies described herein, even spacing between parallel panels, variable spacing between panels, symmetrical spacing and/or positioning of panels, or asymmetrical spacing and/or positioning of panels can be used. In examples where female receiving openings may be horizontally offset in the form of a horizontally offset grid-like structure; or in examples which use non-periodic horizontally varied grid-like structures, alternative spatial relationships between orthogonally joined “teeth” panels along a “spine” panel of the sub-assembly can be present. These arrangements are not specifically discussed in the context of FIGS. 14A-C, but rather, these other types of evaporation panels can be similarly assembled to form similarly configured panel sub-assemblies with just a few minor panel configuration modifications in some instances.

Turning now to a more detailed description of the various sub-assemblies shown in FIG. 14A, the terms “L-shaped” and “T-shaped” are essentially self-explanatory. L-shaped refers to two panels orthogonally positioned where a male connector(s) at one end of a first panel is joined with one (or more) of the laterally outermost female receiving openings (e.g., vertically aligned female receiving openings). The general shape is shown in FIG. 14A and labeled “L-shaped.” T-shaped refers to two panels orthogonally positioned where a male connector at one end of a first panel is joined with any vertically aligned female receiving opening other than those present at the outermost position. Two examples are provided in FIG. 14A which are labeled “T-shaped” and “T-shaped (asymmetrical).” In these examples and others hereinafter, evaporation panels which use their male connector(s) to join with a female receiving opening of another panel can be referred to, for convenience, as a “tooth” or in plural as “teeth.” The evaporation panel which utilizes the female receiving opening to receive a male connector can be referred to as a “spine,” or if there are two (one at each end of the “tooth” or “teeth,” then this second evaporation panel can be referred to as a “secondary spine” for convenience. These terms are used primarily for additional clarity in describing sub-assembly structures.

Another basic sub-assembly structure is referred to herein as “comb-shaped,” which includes three or more panels, where a second and third panel are orthogonally positioned relative to a first panel, and the male connectors of the two panels are each individually joined with the laterally outermost female receiving openings of the first panel. In other words, the two panels, or “teeth” attach to the first panel, or “spine,” at opposite ends thereof within female receiving openings of the first panel. Notably, additional comb teeth may also be positioned between the two outermost comb teeth. Specific examples of comb-shaped sub-assemblies are shown in FIG. 14A, and labeled “Comb-shaped (U-shaped),” “Comb-shaped (E-shaped),” and “Comb-shaped (5 teeth).” The more specific term “E-shaped” indicates that there is one panel between the two outermost panels, the term “5 teeth” indicates that there are three panels between the two outermost panels, and so forth. The U-shaped sub-assembly has no additional panels between the two outermost panels. In one example, a comb-shaped sub-assembly can alternatively be referred to as a “partial cube-shaped” as the teeth at a distal end with respect to the spine can be joined with a cube-shaped sub-assembly or another comb-shaped or a different type of sub-assembly to form a cube, or even to form a series of repetitive cubes with one or more shared common panel. Alternatively, a “cube-shaped” sub-assembly can likewise be referred to as a “comb-shaped” sub-assembly because it includes the spine and the two teeth positioned at both outermost positions. However, the cube-shaped sub-assembly also includes another panel that is joined to a distal end of the teeth as a secondary spine that has a parallel orientation with respect to the spine. An alternative example comb-shaped panel that can be used to form a cube-shaped sub-assembly is shown in FIG. 14A, and referred to as “Comb-shaped (5 teeth).” Unlike the cube-shaped sub-assembly shown in FIG. 13 with evenly spaced teeth, this sub-assembly structure has unevenly spaced evaporation panels or teeth leaving two vertically aligned open spaces with two open positions and two vertically aligned open spaces with three open positions. The inter-panel spaces with three open spaces can be referred to as “enlarged inter-panel spaces” relative to the other inter-panel spaces.

Another sub-assembly shape that can be particularly useful for building strong and potentially quite tall evaporation panel assemblies is the pi-shaped sub-assembly. The term “pi-shaped” can refer to shapes (when viewed from above) which include a first evaporation panel (spine), and a second panel and a third panel (teeth) that are positioned orthogonally with respect to a first panel, leaving at least the outermost female receiving opening positions on the first panel or spine open. Thus, the shape approximates the general configuration of the Greek symbol for pi (π), e.g., at least one panel (the first panel) having the laterally outermost female receiving openings remaining unused or open and including two (or more) orthogonal panels joined thereto. The pi-shaped sub-assembly can be symmetrical, with the same number of outermost female receiving opening positions of the first panel or spine open (e.g., one vertically aligned female receiving opening position on each side, two on each side, etc.), or can be asymmetrical, with a different number of open positions on each side of the first panel or spine open (e.g., one vertically aligned female receiving opening position on one side, and three open positions on the other side, etc.). There are instances where asymmetrical pi-shaped sub-assemblies may be used with symmetrical pi-shaped sub-assemblies to achieve a more ordered evaporation panel assembly as a whole. See for example FIG. 14C, for example. For further clarity, as shown in FIG. 14A, several pi-shaped sub-assemblies are shown from a top plan view perspective and are more specifically labeled therein by example. Additionally, finer or closer cross-hatching is used on some of the pi-shaped sub-assemblies to clearly show which evaporation panels can be considered to be part of the “pi-shape.” For example, one pi-shaped sub-assembly is labeled “Pi-shaped,” and in this example, includes two open laterally outermost vertically aligned female receiving opening columns on each side unused. This pi-shaped sub-assembly could likewise leave only one laterally outermost female receiving opening column on each side unused (or three on each side unused, etc.). In further detail, similar terminology as used to describe the “comb-shaped” sub-assemblies can be used for the individual panels of the pi-shaped sub-assemblies, such as the term “teeth” and “spine.” However, it is noted that a “comb-shaped” sub-assembly places the outermost “teeth” at the laterally outermost positions along the “spine,” whereas, the “pi-shaped” sub-assembly leaves at least the laterally outermost positions along the “spine” open. As a second example, another pi-shaped sub-assembly is labeled “Pi-shaped (5 teeth; asymmetrical; enlarged inter-panel space),” which includes 5 teeth with the outermost teeth being asymmetrically positioned with respect to the unused outermost female receiving opening vertically aligned positions (one column on one side left open and three columns on the other side left open). The enlarged inter-panel space can be useful for generating additional airflow and/or evaporation, each of which includes one or more enlarged evaporation airflow channel(s), shown therein at 58A and 58B. These enlarged channels can be positioned and sized to align with the enlarged inter-panel space, which in this example are centrally located. The term “enlarged” is a relative term meaning that the space between the panels that define this space is larger than other spaces of the sub-assembly. Still another example is labeled “Pi-shaped (6 teeth; secondary spine; enlarged inter-panel space),” which includes three evenly spaced teeth toward one end of the spine, and three evenly spaced teeth toward another end of the spine, again leaving the laterally outermost (e.g., one on each side in this instance) vertically aligned female receiving opening positions open. This arrangement, again, leaves an enlarged inter-panel space. A secondary spine panel is also included that is present at an opposite end of the teeth panels relative to the spine panel.

As a note, when joining multiple sub-assemblies together laterally or vertically to form a more complex evaporation panel assembly, the fact these structures are described as discrete “sub-assemblies” in no way implies that each sub-assembly must be first formed before any two sub-assemblies can be joined together laterally. On the contrary, when building an evaporation panel assembly, multiple panel sub-assemblies may be put together at the same time as one another, panel sub-assemblies can be partially assembled when joined with laterally adjacent panel sub-assemblies or adjacent partially assembled panel sub-assemblies or individual evaporation panels of an adjacent panel sub-assembly, larger evaporation panel assemblies can be formed one evaporation panel at time without regard to the configuration of panel sub-assemblies incidentally formed during a build, or panel sub-assemblies may be fully joined or formed prior to assembling two or more sub-assemblies together to form a larger evaporation panel assembly. In other words, “sub-assemblies” are defined herein to describe portions of the evaporation panel assembly, once assembled, and does not imply that sub-assemblies must first be put together before joining respective panel sub-assemblies, unless the context dictates otherwise.

FIG. 14B shows a top 12 plan view of twenty (20) evaporation panels of an evaporation panel assembly used to form an evaporation tower 200, where the evaporation panels are joined laterally to one another to form a pinwheel-like configured evaporation panel assembly. Though obscured and thus not labeled or shown in detail, individual evaporation panels can include a plurality of stacked shelves, support columns, female receiving openings, etc., as previously described. From this view, some of the uppermost and unconnected male connectors 40 remain visible, but can be used if the evaporation panel assembly is laterally built out further. Without naming each evaporation panel specifically, suffice it to say that there are ten evaporation panels that are oriented parallel to one another, and there are ten evaporation panels that are connected therewith in an orthogonal orientation therefrom. In further detail regarding the pinwheel-like configuration, in reality, this configuration can be viewed as a collection of four identical pi-shaped sub-assemblies, similar to those shown in FIG. 14A. The exact pi-shaped structure in FIG. 14B is not specifically shown in FIG. 14A, but could be labeled similarly as “Pi-shaped (4 teeth).” This particular arrangement is symmetrical with only one vertically aligned female receiving opening left open on each end of the spine thereof.

There are several advantages to using one or more pi-shaped sub-assemblies in forming an evaporation panel assembly. For example, as shown in FIG. 14B, in its current form, this particular evaporation panel assembly is shown with twenty evaporation panels, where five evaporation panels are used to assemble each pi-shaped sub-assembly. However, this same type of sub-assembly can be used to build the evaporation panel assembly out laterally (as shown by the solid line arrows). Furthermore, as with other evaporation panel assemblies, this assembly pattern can also be built up vertically. This particular assembly pattern, however, provides added strength and more resistance to the potentially crushing forces of gravity when the evaporation panel assembly (which can already be relatively heavy unloaded, particularly when stacked 16 feet, 24 feet, 36 feet, or more in height) is fully loaded with impure water. Essentially, in this configuration, where four evaporation panels come together in a tight pattern, a structural post or vertical support beam assembly 68 can be formed, which can provide a higher resistance to significant weight loads on the evaporation panel assembly, as well as provide rotational shear resistance in at least four lateral directions (at 90 degree intervals). Thus, essentially at one concentrated location, four evaporation panels, each at an end thereof due to the pi-shaped sub-assembly configuration, come together and contribute to the formation of a hollow vertical beam that is integrated into the evaporation panel assembly, and further, this integration of the support beam assemblies occurs incrementally as the evaporation panel assembly is being constructed. This can provide added safety to an assembly technician as vertical support beam assemblies are incrementally formed during the build, providing essentially real-time formation of vertical support beam assemblies for added vertical strength with respect to holding weight as well as rotational shear resistance. In short, there is no separate beam structure included or added to provide this extra level of vertical support and shear resistance in this example. Furthermore, by using a pi-shaped type of sub-assembly configuration, vertical support (and shear resistance) beam assemblies can be present at essentially every interval equal to about the length of an individual evaporation panel in a grid-like formation. Thus, if the evaporation panel is two (2) feet in length, about every two feet (e.g., just under two feet), there may be a vertical support beam assembly formed, which can be characterized in some examples as forming an array of structural beams positioned in a grid-like formation in the x-y axes (as viewed from above). An example of a grid-like array of structural beams can be seen in FIG. 16, wherein one vertical support beam is identified at 68. That particular example also includes large vertical airshafts 208 (about the size of a single sub-assembly). However, the grid-like array of vertical support beam assemblies may be formed as part of an evaporation panel assembly that does not include these vertical airshafts. Returning to FIG. 14B, also as shown around a periphery of the evaporation panel assembly, there may be partial vertical support beam assemblies 68A that can provide some additional vertical support, but can also be used to generate more vertical support beam assemblies as the evaporation panels or evaporation panel sub-assemblies are used to build the evaporation panel assembly further out laterally.

As shown in FIG. 14B, inter-panel spaces 39 can be relatively wide, e.g., three vertically aligned female receiving opening spaces between each panel, or the inter-panel spaces can be narrower, such as shown in FIG. 14C. For example, inter-panel spaces can be provided by omitting two panel spaces, three panel spaces, four panel spaces, etc., between parallel evaporation panel teeth. FIG. 14B in particular shows three panel spaces omitted between parallel oriented and adjacent evaporation panels, providing even more evaporation and/or airflow 38A, 38B and 38C compared to the cube-shaped configuration of FIG. 13 (which could also include more spacing in other examples) where there was only one inter-panel space. In areas where the ambient conditions are very dry and hot, less space may be present and used for an efficient and compact design. However, when the ambient conditions are not as hot and/or more humid generally, evaporation panel assembly designs that allow for more open evaporation space may be beneficial, e.g., such as that shown in FIG. 14B. The inter-panel spaces can, for example, provide for vertical airflow and/or water vapor clearing initiated by airflow patterns shown in this FIG., for example. On the other hand, in some instances, small spaces for directing airflow may provide improved evaporation results, as narrower openings can lead to higher airflow velocity. Thus, each evaporation panel assembly can be designed taking into account such considerations and conditions. Thus, the evaporation panels and systems of the present disclosure can be customized not only with design practicality in mind, but also with ambient conditions considered. In further detail, the density and spacing of the evaporation panels of evaporation panel systems can be assembled in a manner that varies greatly both laterally and in height. By varying the density of evaporation panels within an evaporation panel assembly, warm to cold air exchange within the evaporation panel assembly can be tuned to promote enhanced movement of air. Furthermore, in drier/less humid regions, one design may be effective, and in higher humidity regions, alternative designs and/or spacing profiles may be used for a more customized and efficient evaporation profile.

In further detail with respect to FIG. 14B, various possible airflow patterns are shown. Airflow pattern 38A shows airflow in the x axis direction (from a top view perspective) and airflow pattern 38B shows airflow in the y axis direction. However, due to the shape and configuration of the support columns (not shown in this FIG., but shown in greater detail by example in FIGS. 4A-10), airflow can be directed into, through, and out of the evaporation panel assembly efficiently. In one example, airflow pattern 38C is shown where external airflow is provided from an oblique angle with respect to any of the evaporation panels, but can be efficiently brought into the evaporation panel assembly through open spaces or (unused) female receiving openings to assist with evaporation.

FIG. 12C shows a top 12 plan view of sixty-nine (69) evaporation panels of an evaporation panel assembly or an evaporation tower 200, where the evaporation panels are joined laterally to one another to form an essentially cuboidal- or rectangular cube-like shape (with some recesses and protrusions around the periphery—not to be confused with the cube-shaped sub-assembly previously described). More specifically, this evaporation panel assembly can be viewed as multiple pi-shaped unit structures or sub-assemblies, each with one evaporation panel spine oriented orthogonally with respect to six (6) or seven (7) evenly spaced apart evaporation panels, e.g., teeth. Thus, this arrangement includes three asymmetrical pi-shaped sub-assemblies (shown for clarity using large cross-hatching) and six symmetrical pi-shaped sub-assemblies (shown for clarity using small cross-hatching). These sub-assemblies are thus identified in this FIG. by example only, as the same large assembly structure (including all 69 panels) can be formed using differently-defined sub-assemblies than those identified by the varied cross-hatching in this example. To illustrate, considering three of the nine sub-assemblies shown in FIG. 12C as an example, the upper right and upper left (as shown in this FIG., but again, as viewed from above) sub-assemblies could both be considered as seven (7) teeth, symmetrical, pi-shaped sub-assemblies, each with a secondary spine (see orthogonal, small cross-hatched evaporation panel at the end of the respective teeth of the upper right and upper left sub-assemblies, respectively). Under this alternative definition, the central sub-assembly at the top of the drawing sheet could then be considered a five (5) teeth, symmetrical, pi-shaped sub-assembly with three outermost female receiving openings remaining open at each end of the spine. Regardless, by defining the various pi-shaped sub-assemblies in this way, the resulting large assembly (of 69 evaporation panels) would still be the same. However, in both examples, the respective sub-assemblies can each still be considered generally “pi-shaped.” The pi-shaped sub-assembly configuration of really any type (e.g., symmetrical, asymmetrical, 2 to 7 or more teeth, with or without a secondary spine, with or without central inter-panel space, with or without a vertical airshaft, etc.) can thus provide the ability to generate large evaporation panel assemblies or towers with enhanced vertical compression strength, rotational shear resistance, and highly stable orthogonal joints junctions. It is worth noting that some of these ranges, such as “2 to 7” teeth, etc., in this and other examples are provided by example only, as these ranges may be more aptly based on the number of total vertically aligned open space positions that may be present on the evaporation panels of the evaporation panel system or assembly.

With respect to enhanced vertical compression strength (e.g., the ability to build the structure higher without crushing the bottom or lower levels) and enhanced rotational shear strength (e.g., the ability to resist shear forces strength) mentioned in FIG. 14B, in this particular example as well, the pi-shaped sub-assemblies can be likewise joined to form vertical support beam assemblies 68 positioned in a grid-like formation. In this example, the grid-like formation includes four vertical support beam assemblies and eight partial vertical support beam assemblies 68A. The vertical support beam assemblies, in particular, can structurally provide a similar type of support that a vertical post or beam would provide to support an upper floor or a multi-level building in engineered construction, with the added benefit of providing rotational shear resistance because of the assembly construction. Furthermore, as with the design shown in FIG. 14B, the evaporation panel assembly configuration shown in FIG. 14C can be further built out laterally (as indicated by the solid arrows pointing outward or laterally from the basic sub-assembly shapes shown) in a repetitive or semi-repetitive manner.

Though not labeled or shown in close detail, the individual evaporation panels can include a plurality of stacked shelves, support columns, female receiving openings, etc., as previously described. From this view, some of the uppermost and unused male connectors 40 are visible. Without naming each evaporation panel specifically, suffice it to say that there are thirty-two (32) evaporation panels that are oriented parallel to one another, and there are thirty-seven (37) evaporation panels that are connected therewith in an orthogonal orientation therefrom. In this configuration, similar to the example cube configuration shown in FIG. 13, there is one panel space, or inter-panel space 39, left between parallel and adjacent evaporation panels. This configuration allows for a more densely packed arrangement of panels (compared to FIG. 14B) while still allowing for often adequate evaporation space to exist between evaporation panels, particularly in drier conditions or when the evaporation panel assembly is not laterally built out with a large footprint. With larger footprint assemblies where inner areas of the evaporation panel assembly are a further distance from an outer surface of the assembly, extra vertical or horizontal airshafts can be assembled therein to compensate (not show, but shown in FIG. 16 by way of example) based in part on the ambient conditions. This arrangement may be more useful when the conditions might be drier than other arrangements where more space remains between the panels, for example. As mentioned, other panel spacing can also be designed, e.g., 2 spaces, 3 spaces, 4 spaces, etc. Also, though airflow patterns are not shown in this example, they can be similar to that shown in FIG. 14B.

Again, though not specifically labeled or shown in close detail, the individual evaporation panels can include a plurality of stacked shelves, support columns, female receiving openings, etc., as previously described. From this view, some of the uppermost male connectors 40 are visible. In this configuration, similar to the cube configuration shown in FIG. 13, there is generally one panel space, or inter-panel space 39, left between parallel and adjacent evaporation panels or teeth. This configuration provides a more densely packed arrangement of panels (compared to FIG. 14B) while still often allowing adequate evaporation space to exist between evaporation panels, depending on evaporation panel assembly size (lateral footprint and height) and the ambient conditions. This arrangement may be more useful when the conditions might be drier than other arrangements where more space remains between the panels, for example. As mentioned, other panel spacing can also be designed, e.g., 2 spaces, 3 spaces, 4 spaces, etc. Though airflow patterns are not shown in this example, they can be similar to that shown in FIG. 14B.

In more specific detail, this embodiment provides another unique example which utilizes multiple versions of the pi-shaped sub-assembly, including a sub-assembly with six (6) evaporation panels (one pi-shaped asymmetrical), sub-assemblies with seven (7) evaporation panels (three pi-shaped asymmetrical with secondary spine; and three pi-shaped symmetrical), and a sub-assembly with eight (8) evaporation panels (one pi-shaped symmetrical with secondary spine). Some of the pi-shaped sub-assemblies include five (5) teeth, and others include six (6) teeth. Some sub-assemblies include a single spine, others include two (2) spines, e.g., a spine and secondary spine. Furthermore, some sub-assemblies are symmetrical and others are asymmetrical. Once joined together, however, each sub-assembly can share an evaporation panel(s) with adjacent sub-assemblies, thus providing a more uniform evaporation panel assembly structure that can form a repeatable pattern. Furthermore, in this particular configuration, though evaporation panels including those shown in FIGS. 4A-6 or others can be used, other evaporation panel configurations can likewise be constructed and used.

Turning now to FIG. 15, a perspective view illustrating two adjacently positioned assembly towers including a first evaporation panel assembly of a first evaporation tower 200A and a second evaporation panel assembly of a second evaporation tower 200B are shown. Notably, the two evaporation panel assemblies can be spaced apart at the bottom leaving a passageway 202 wide enough for a human operator to enter for purposes of passage, inspection, repair, cleaning, building, etc. In this example, the passageway can be about the width of one evaporation panel sub-assembly, or other distance therebetween as may be practical. At an upper portion of the respective assembly towers, the evaporation panel assemblies can include a cantilevered bridging portion 204, which spans or mostly spans the width of the passageway. The cantilevered bridging portion can provide safe passage for a human operator to move from one tower to the next. In this specific example, a small distance (d) or gap 206 can be left or remain between the two evaporation panels or towers to protect against seismic shifting or other unforeseen movement that may occur at one evaporation panel assembly but not necessarily at the adjacent evaporation panel assembly. By isolating adjacent evaporation panel assemblies from one another by leaving a small distance (d) or gap, e.g., d=½ to 12 inches, d=1 to 6 inches, d=2 to 5 inches, d=3 to 5 inches, d=3 to 4 inches, or d=6 to 12 inches, etc., damage to one evaporation panel assembly can be isolated without carrying through to a much larger, and thus, more complex evaporation panel assembly. In some examples, the cantilevered bridging portion and/or the passageway may be removed, and the towers can be simply placed a distance (d) from one another. However, such an arrangement would not permit a human operator to move freely therebetween.

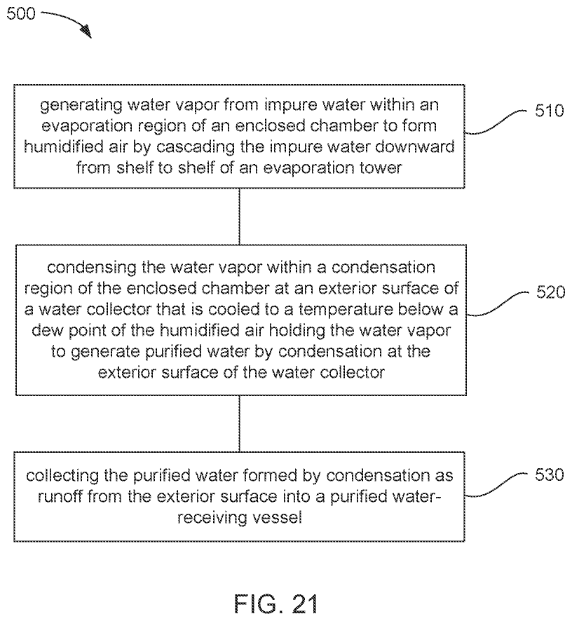

In further detail, the first evaporation panel assembly of a first evaporation tower 200A and/or the second evaporation panel assembly or a second evaporation tower 200B can include a wall portion 210, also built from evaporation panel sub-assemblies assembled from individual evaporation panels. In this instance, the wall is shown as built at a height of two “cube sub-assemblies,” which in one example can be about 4 feet high if individual evaporation panels are about 2 feet in length. However, the basic configuration can be similarly prepared using pi-shaped sub-assemblies or other comb-shaped sub-assemblies. The wall can provide human operator safety when walking on top of one or both evaporation panel assemblies or towers. In this particular example, there can also be vertical airshafts 208 also designed into the evaporation panel assemblies to facilitate airflow and/or evaporative water vapor clearing from within the evaporation panel assembly. Thus, airflow and/or water vapor clearing from the evaporation panel assembly can occur either horizontally or vertically. To illustrate, with respect to horizontal airflow and water vapor clearing, open spaces (dedicated open spaces 48 shown in particular in FIGS. 17, 18, and 20; and unused female receiving openings 42 providing open spaces shown in FIGS. 1-9, 18, 21A-24, etc.), enlarged evaporative airflow channels 58A and 58B (shown in FIGS. 21A-24D), inter-panel spaces 39 (shown at least in FIGS. 9, 14B, and 14C), enlarged inter-panel spaces 28 (shown in FIGS. 14A and 16) often aligned with enlarged evaporative airflow channels, and/or horizontal airshafts (not shown, but which can be formed by leaving a horizontal shaft which does not include (is devoid of) sub-assemblies along that horizontal shaft location) can allow for the inflow or outflow of air and/or water vapor horizontally. With respect to vertical airflow and water vapor clearing, the vertical airshafts, shown by example at 208 in this FIG. as well as in FIG. 16, inter-panel spaces 39, and enlarged inter-panel spaces 28 allow for airflow and evaporation. For example, a chimney effect can occur at the vertical airshaft and vertical airflow can occur in between individual evaporation panels at the inter-panel spaces and/or enlarged inter-panel spaces.

In further detail, in one example, access to a top portion of the evaporation panel assembly can be provided by stairway 212, which can be assembled using evaporation panels or evaporation panel sub-structures integrated into the overall structure of the evaporation panel assembly or tower. In this example, the stairway is provided by evaporation panels that are about half the height of the other evaporation panels. This is an example of where it may be advantageous to use differently configured or sized evaporation panels. However, in other examples, full evaporation panel sub-assemblies could be used to form larger stairs, e.g., stairs 2 feet in height if the evaporation panel sub-assemblies are likewise two feet tall. In either case, in this and other examples, multiple evaporation panel sub-assemblies or evaporation panels individually can be used and configured to provide any of a number of structural features, such as a stairways, passageways, safety barriers or walls, vertical airshafts, cantilevered bridges, open rooms, benches, or the like, formed primarily or even completely from assembled evaporation panels. Furthermore, multiple assembly towers can be built in close proximity to one another and spaced apart at a small distance (d), as mentioned, as may be desired based on space or other constraints to protect against damage from tower to tower in the event of a tower failure of some type. These and other similar evaporation panel assemblies or towers used as part of a larger impure water remediation or evaporative separation system or as part of a cooling tower system, including with any of the other components shown and described in FIGS. 33 and 34, can be assembled or associated therewith, e.g., fluid pumps, sprayer nozzles or distribution pans, delivery pipes or tubing, grating or perforated platforms (upper and/or lower), etc. For reference, an approximately 6 foot tall human operator is shown in FIG. 15 for scale.

In further detail, FIG. 16 depicts a top plan view illustrating four (4) evaporation panel assemblies four evaporation towers 200A-D. Adjacent assemblies or towers include passageways 202 and cantilevered bridging portions 204 with gaps 206 therebetween. Only a portion of evaporation panel assembly evaporation towers 200 B-D are shown, but these evaporation assemblies can be the same size as evaporation assembly 200A, or can be of different sizes. With specific reference to evaporation tower 200A, the general sub-assembly configuration used to form this particular evaporation panel assembly is pi-shaped, as described generally in FIGS. 14A-C, and more specifically with respect to the assembly of pi-shaped sub-assemblies with vertical airshafts 208 and vertical support beam assemblies 68. In other words, the vertical airshafts can be formed in a straightforward manner by slightly modifying the pi-shaped assembly pattern shown and described with respect to FIGS. 14B and 14C to omit the addition of certain evaporation panels. Thus, the pi-shaped sub-assemblies in this example do not include the same number of evaporation panels in every sub-assembly, but rather a varying number and configuration of various sub-assemblies can be used. In this specific example, some sub-assemblies can include six (6), seven (7), or eight (8) evaporation panels, depending on how the pi-shaped sub-assemblies are characterized.

With specific reference to evaporation panel assembly of an evaporation tower 200A, each level can include 896 individual evaporation panels, 138 evaporation panel sub-assemblies, and from 2 to 30 levels, e.g. 4 to 60 feet when each level is 2 feet tall, or even more levels in some instances. By way of example, if evaporation panel assembly of the evaporation tower 200A includes twelve (12) levels, for example, there may be 10,752 individual evaporation panels used. If there are four towers of equal size and dimensions, then the structure grouping shown in FIG. 16 would include 43,008 individual evaporation panels. At this size and dimension, with four closely positioned towers, the surface area of impure water remediation or treatment, or water cooling, can be immense with a footprint of less than about 3000 square feet. Considering examples where each panel can have many shelves, e.g., 8 to 36, 12 to 32, 16 to 24, etc., when vertically stacked, there may be close to 3000 square feet of 96 to 432 levels of shelves (of varying density or widths, depending on the specific assembly configuration). Furthermore, with a very large number of evaporation columns, e.g., from 4 to 24, from 8 to 20, etc. (horizontally offset or aligned) per evaporation panel, with each column including many individual evaporation fins, e.g., from 25 to 150 evaporation fins per column, the available surface area for impure water evaporation to occur can be significantly increased. Notably, when using evaporation panels with the enlarged evaporative airflow channels, there may be less surface provided by the shelves and/or the evaporation fins per square foot, but this deficiency can be compensated by increasing the tower height by one or two levels without significant weight increase (because each panel weighs less due to the use of less material to form the individual evaporation panels).

In another example, an example impure water evaporative separation system is shown in FIG. 17, and can include by way of example an evaporation panel sub-assembly or assembly of an evaporation tower 200 and an impure water delivery system, which in this example includes any of a number of pumps, plumbing, and the like. In this example, there are multiple alternative delivery systems that are shown which can be used in any combination, but are shown together for explanatory purposes. This example is shown to illustrate some of the equipment that can be used not only with respect to separation of contaminants or other particulates, but with other related systems, such as the evaporative cooling systems of the present disclosure. Thus, in this particular example, though some features may not be relevant to evaporative cooling per se, this example is still illustrative of various features that can be used in the context of evaporative cooling, e.g., evaporation panel sub-assembly, fluid directing devices or plumbing including pumps, pipes, tubes, water distribution directors, e.g., sprayer nozzles, distribution pans, distribution troughs, etc. These and/or other structural devices or systems can be used to deliver water to be cooled to an evaporation panel assembly or sub-assembly, and/or further to recirculate the water as needed for continued cooling at locations such as at a commercial air conditioning or industrial plant cooling tower.

With this background in mind regarding the relevance of the following example to cooling towers as well, an impure water evaporative separation system can include an evaporation panel sub-assembly or assembly used to form an evaporation tower 200 and an impure water delivery systems or fluid directing assemblies for flowing (e.g., pumping and/or gravity), directing, e.g., pipes, tubes, fluid channels, etc.), and delivering (sprayers, sprinkler heads, distribution pans, distribution troughs, etc.) impure water generally to a top portion of the evaporation panel assembly, e.g., a fluid pump 62 can deliver impure water from a body of impure water 60 (or some other reservoir of water, such as a vessel that contains water to be cooled) via a delivery pipe or tube 66 to a sprayer nozzle(s) 64 above or beside the evaporation panel assembly. With larger evaporation panel assemblies, a series or sprayer nozzles or large scale fluid delivery apparatuses can be used that are suitable for delivering impure water which can, in some cases, include solids or other contaminants that are also deliverable within the impure water to the top of the evaporation assembly. In another example, the delivery system can include fluid pump 92A and one or more delivery pipes or tubes 66 that can be used also to receive, direct, and ultimately deliver impure water from the body of impure water (or other body of water) to a distribution pan 78 disposed above the evaporation panel assembly. The distribution pan can include a series of perforations or voids 76 through which the impure water and any contaminants or other materials, if applicable, contained therein can be delivered without clogging the perforations, and/or so that the impure water can be evenly distributed across a top of the evaporation panel assembly.

In a more specific example, the distribution pan 78, which can be used with evaporative cooling as well, can be reconfigured to facilitate additional airflow by more closely matching the shape of the distribution pan (thereabove) to a shape of individual evaporation panels, individual evaporation panel sub-assemblies, or other smaller unit of top loading surface on the evaporation panel assembly. Thus, the smaller series of distribution pans can be configured to likewise leave openings between separate distribution pans, or even fluidly interconnected distribution pans, or larger groups of distribution pans thereof (further interconnector or separate). These distribution pans or groups of distribution pans can thus be configured like elongated troughs (e.g., having a rain gutter-like configuration) with openings along the bottom that can be aligned with a top surface of individual evaporation panels, which can be repeated across the top surface of the evaporation panel assembly (or a portion thereof) to more precisely load the assembly with the impure water. Such a configuration would allow for more vertical airflow and water vapor venting to occur, as opposed to a large airflow blocking distribution pan that may leave little to no effective vertical airflow venting space, thus relying more so on venting elsewhere. In one example, the distribution pan in this configuration can be referred to more specifically as a series of distribution troughs, or even a series in interconnected distribution troughs. These troughs can be configured to attach directly to a top surface of an evaporation panel, in one example, potentially using some of the structural features previously described herein that may already be present at or near the top surface of the evaporation panels described herein. An example of a modular system of interconnected troughs usable for distributing impure water 50 to a top of a plurality of evaporation panels is shown in some detail in FIGS. 18A-C hereinafter.

Though a distribution pan 78 (or even a system of distribution troughs) may be used to more precisely apply the impure water to a top portion of the evaporation panel assembly, a sprayer nozzle or series of sprayer nozzles (without the distribution pan) can also provide an effective way to load the evaporation panel assembly, even if some of the impure water is not as efficiently loaded thereon. This can be particularly the case when the evaporation panel assembly is positioned near or above the body of impure water that is being treated. For example, when impure water is applied at or near the top of the evaporation panel assembly and a portion of the impure water does not become loaded during application, such as because one or more sprayer nozzles is used which may not be a particularly precise delivery fluid delivery system, the impure water that is not loaded on the evaporation panel assembly during the fluid application process (e.g., that falls between the inter-panel spaces, falls through the vertical airshafts, spills from the evaporation panels due to overfilling, etc.) can be merely returned back to the body of impure water by gravity. Then, at a later point in time, the impure water can be re-pumped back to the top at a later delivery or loading event, or can be pumped back to the top at a later point in time during the continuous loading process, for example. Return of the impure water that is not loaded on the evaporation panel assembly back to the body of impure water can either be as a result of the evaporation panel assembly being positioned over the body of impure water, or the evaporation panel assembly being located nearby the body of impure water so that the impure water that is to be returned to the body of impure water can be returned via a water return channel, for example. Other methods of impure water return can also be carried out, including through the use of pumps, from vessels or ponds that are adapted to receive water at a bottom of the evaporation panel assembly to be delivered back to a top thereof, etc.

In one example, the evaporative water tower 200 of the impure water remediation or evaporative separation system or evaporation tower 200 can be associated with a platform 80A configured to support the evaporation panel assembly (of any shape or configuration or appropriate size relative to the size of the platform). The platform can be, for example, a floating platform that floats on the surface of the body of impure water or is otherwise suspended or partially suspended above the body of impure water. The floating platform for example, if used, can be free floating on an impure water pond, for example, or can be anchored to the ground using a dock cable system (attached to the pond floor or to dry land), or can support the evaporation panel assembly over or near the vessel for recirculation. The platform can alternatively be in a fixed position (not floating), and the impure water can be filled up or otherwise present around the platform, or partially around the platform. The platform can also be perforated or can include open spaces for allowing impure water falling from or through the evaporation panel assembly to pass through and in some examples, ultimately return to the impure water body of water. Suitable configurations can include a grid which defines open rectangular or square channels, or other structure that defines open channels of any other shape in any suitable pattern to allow impure water to pass efficiently therethrough. In still other examples, the impure water can be loaded from a vessel (not shown), such as a tank, where the impure water is either pumped up to load the impure water at or near the top of the evaporation panel assembly, or where the impure water is gravity fed from the vessel from a relative high location to a lower elevation (at a top portion of the evaporation panel assembly). Regardless of whether gravity fed, pumped, or both, the vessel can be either in close proximity or at a further distance relative to the evaporation panel assembly. In other words, the impure water can be loaded onto an evaporation panel assembly by any method that is practical, e.g., with or without valves, pumping upward from a body of impure water of lower elevation, gravity fed from a higher elevation body of impure water, from an impure water pond or other body of water, from an open or closed vessel, to sprayer(s), to sprinkler head(s), to distribution pan(s), etc.

Evaporation towers 200 for impure water evaporative separation can also be set up in accordance with other examples of the present disclosure. For example, a fluid pump 92B (and console or control module) can be adapted to draw from a source body of impure water 90 (not equipped with an evaporation panel assembly) via a delivery pipe or tubing 96 to a body of impure water 60 proximate to an evaporation panel assembly that forms an evaporation tower 200, such as for example a large open vessel, a lined impure water pond, or an already existing impure water pond. The evaporation panel assembly can be positioned over (or proximate to) the body of impure water that is remote from the source body of impure water to be treated. Criteria for impure water delivery from the source body of water to the evaporation panel assembly (or the second body associated therewith) can be based on various predetermined criteria. Examples of such criteria can include i) keeping the second body of water full (or at least at a certain predetermined minimum depth) for efficient use with the evaporation panel assemblies described herein; and/or ii) maintaining and/or monitoring the depth or other conditions of the source body of water so that the system can be shut down if conditions are not desirable. If conditions are not desirable in either the source body of water and/or the second body of water, alerts with manual shut down procedures or automatic shutdown procedures can be implemented. In further detail, similar systems can be in place so that multiple source bodies of water can feed impure water to a single evaporation panel assembly and/or second body of water, or a single source body of water can feed impure water to multiple evaporation panel assemblies and/or second bodies of water.

In another example, impure water evaporative separation (or remediation) system or evaporation tower 200 components shown in FIG. 17 can be modified for alternative configurations or uses of the evaporation panel assemblies that form the evaporation tower 200, or others can be part of adjacently (laterally) locked and vertically stacked evaporation for use in these or other similar impure water evaporative separation systems. For example, these example evaporation panel assemblies can likewise be used for evaporative cooling systems in accordance with the present disclosure. It is notable, however, that evaporation panels can be assembled together in some of these types of configurations, but also in other configurations limited only by the creativity of the user, the dimensions of the evaporation panels, and the usable footprint. Thus, using these evaporation panels as basic building blocks, very complex structures can be formed, including large structures the size of rooms or buildings, with weight bearing structures such as stairways, platforms, etc., and with open spaces such as doorways, rooms, etc., and/or with safety features such as upper platform walls and bridges, or any other structural feature imaginable that can be built using essentially rectangular building blocks, for example. To illustrate, in one example, at least 10 discrete evaporation panels can be locked together. In another example, at least 50 (or at least 100) discrete evaporation panels can be assembled with a first portion being locked together and a second portion separately locked together and stacked on top of the first portion. In another example, at least 500 (or at least 1,000, at least 5,000, at least 10,000, at least 50,000, etc.) discrete evaporation panels can be assembled with a first portion locked together, a second portion separately locked together stacked on top of the first portion, and a third portion locked together and stacked on top of the second portion, and so forth. Stacking can occur incrementally by building a level on top of an existing level. Stacking can also allow for building very high evaporation panel assembly towers or other structures, limited only by the safety and weight bearing capacity of the evaporation panels that are locked together, e.g., 40 feet, 100 feet, etc. On the other hand, laterally locking evaporation panels together is not particularly limited at all, being limited only by the available footprint. A few example towers or evaporation panel assemblies, as well as two example closely positioned grouped evaporation panel assemblies, are each prepared from many evaporation panels joined, and in some cases locked together, and stacked vertically.

FIGS. 18A-C depict various troughs with open channels 402. Specifically a bi-directional channeling trough 410 is shown in FIG. 18A and both bi-directional channeling troughs and redirecting channeling troughs 420 connected using trough connector clips 408 are shown in FIGS. 18B-C. The troughs are positioned on top of an evaporation panel 10, with the foot supports 404 positioned on a top 12 surface of the evaporation panel. More specifically, coupling grooves 46 (similar to the coupling grooves at the bottom of the panel described previously) of the foot supports can be positioned on coupling ridges 44 of the evaporation panel to ameliorate lateral slippage or unwanted movement. In this example, the perforations or voids 76 are positioned over the top surface of the evaporation panel to allow (waste) water in the water delivery trough system to be dropped directly thereon. The other structures are similar to that described previously in various examples. Furthermore, FIGS. 18B and 18C show a top plan view and a side plan view of four redirecting channeling troughs connected together to form a water supply opening 490. There are also two bi-directional channeling troughs shown. The vertical water supply opening can be aligned with an opening within a vertical support beam assembly of an evaporation panel assembly. Thus, a delivery pipe 66 (shown in cross-section at G-G in FIG. 45A based on G-G shown in FIG. 45B) or other fluid directing channel can be positioned vertically within the vertical support beam assembly of the evaporation panel system and also through the water supply opening of the water delivery trough system to deliver impure water (or water) to a location above the water delivery trough system and into the open channels 402. At the top of the delivery pipe, a nozzle or other fluid directing hardware can be used to control or direct the flow of water, if desired. The foot supports, redirecting channel troughs, perforations, redirecting openings 422, and connection lips are shown for reference.

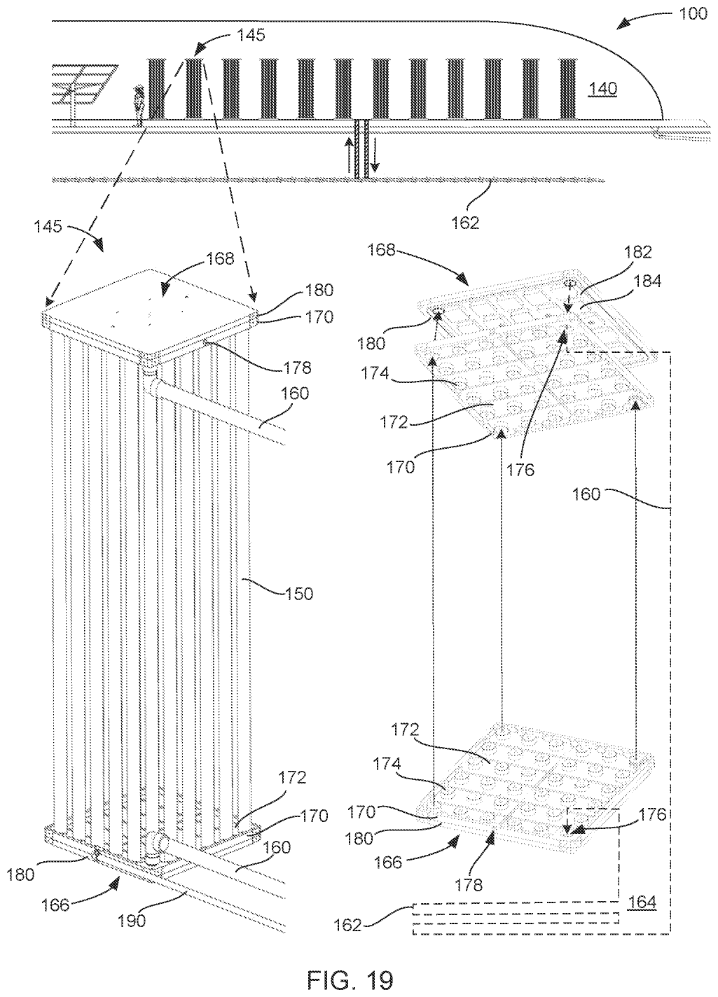

Referring now to FIG. 19, a partial view of a condensation region 140 of a water purification system 100 is shown. As shown herein, and described previously in greater detail in the context of FIGS. 1-3B, a condensation assembly 145 is shown, with assembly parts thereof in greater detail therebeneath. In this FIG., the condensation assembly includes a plurality of water collectors 150. There can be, for example, from about 2 to about 128 water collectors as part of a condensation assembly. However, in this specific example, there are 35 water collectors, and individually, the water collectors include a cooling channel (not shown, but shown at 156 in FIG. 20) to circulate coolant therethrough. The coolant in this example flows through the water collectors in parallel to cool an exterior surface thereof, and then the coolant (warmed by the process of cooling the exterior surface) is combined into a coolant return 160, where it may be re-cooled for further circulation. For example, cooling may occur within a sub-surface cooling portion 162 of the coolant return, which may be buried or submerged in a sub-surface cooling region 164, e.g., underground, underwater, etc., for geothermal cooling. In other examples, if geothermal cooling is not used, cooling of the coolant can occur along the coolant return using other cooling systems, devices, and/or compositions, such as refrigerant systems, transformer cooling systems, convection cooling systems, liquid cooling systems, forced-air cooling systems, cryogenic cooling, evaporative cooling systems, natural draft cooling systems, etc. In some examples, coolant can be cooled to the temperature at or near the temperature of water if submerged in a body of water, or can be cooled to the temperature at or near the temperature underground, which is fairly constant several feet underground, regardless of the climate. For example, temperatures from about 60° F. to about 70° F. are common a few feet beneath the earth surface, even in very warm or hot climates.

In this example, the coolant is channeled from the water collectors 150 to the coolant return 160 through a coolant supply manifold 166 (to supply coolant to the cooling channels of the water collectors) and through the coolant return manifold 168 (to collect warmed coolant to be re-cooled via flow through the coolant return). In this instance, the coolant supply manifold and the coolant return manifold are the same structures positioned parallel to one another, but are also oriented 180° relative to one another so as to face each other. The respective manifolds each include a connection plate 170 which is positioned more proximal to ends of the water collectors, and a coolant channeling plate 180. The coolant return manifold interacts with coolant flow. On the other hand, the coolant supply manifold interacts both with coolant flow and water collection. More specifically, the coolant supply manifold (the bottom manifold) channels coolant through the water collectors and the coolant return, and separately, uses a separate flow path to collect and transport purified water that is condensed from water vapor and collected. For example, the connection plate includes pan portion that acts as a purified water-receiving pan 172. Thus, the pan portion collects water runoff from the water collectors, and then allows for water channeling therefrom through a purified water outlet 178 connected to a purified water line 190. The water collectors in this example are connected to the connection plates at a plurality of water collector connectors 174, which have openings for passing coolant therethrough. The coolant return connects (or passes through) a return receiving opening 176 so that the coolant can flow between the connection plate and the coolant channeling plate. The connection between individual water collectors and the water collector connectors can include a seal, such as an O-ring, to prevent contact between the coolant passing therethrough and purified water that is collected. Thus, the pan portion receives and channels the purified water, and the space between the connection plate and the coolant channeling plate channels the coolant, and the purified water and the coolant do not come in contact with one another. The coolant channeling plate in this example includes open coolant channels 182 to allow for coolant flow into the water collectors at the coolant supply manifold and coolant flow out of the water collectors at the coolant return manifold. The open coolant channels are closed by a joining surface of the connection plate, as well as a plurality of protrusions 184 that may abut areas of the joining surface of the connection plate. Notably, the purified water outlet 178 shown at the coolant return manifold (the top manifold) goes unused, as it is the coolant supply manifold that is where the water is collected beneath the water collectors. This purified water outlet is present in the upper manifold in this example because the two plates used to form the two manifolds are the same structures for manufacturing convenience, but the purified water outlet in this example is only used at the purified water-receiving pan where there is purified water being received, e.g., at the lower manifold.

Referring now to FIG. 20, a side plan view of a condenser assembly 145 is shown, with additional detail shown with respect to the water collectors 150, as well as a purified water-receiving pan 172 (or pan portion of the manifold) and the coolant return opening 176 of the connection plate 170 of the coolant supply manifold 166. As previously described, the condenser assembly also includes a coolant return manifold 168. The manifolds include both the connection plate, as well as a coolant channeling plate 180. A coolant return is shown in part as connected to the two respective manifolds. The coolant supply manifold (the lower manifold) also shows a purified water line 190 fluidly coupled to the pan portion through a purified water outlet (not shown) through a wall of the connection plate.

An example water collector 150 is shown in detail which includes exterior condenser fins 152 that radiate or outwardly protrude along an outer surface of the water collector. In this example, the exterior condenser fins are vertically oriented and radiate outward from a central tubular surface, increasing the surface area of the water collector surface. The increased surface area provides additional surface for water vapor to be condensed, and the vertically oriented exterior condenser fins allow for the purified water 130 collected by condensation to run freely down the exterior surface to be collected at the purified water-receiving pan 172 (pan portion of the coolant supply manifold 166) of the connection plate 170. Notably, the exterior condenser fins may or may not be vertically oriented, provided the fins are designed to allow the purified water that is condensed and collected to flow along a surface thereof, e.g., gravity flow, to be received by one or more water-receiving vessel. Furthermore, in this example, a cooling channel 156, which is channeled to allow coolant 158 to pass therethrough without contacting the purified water, can also include cooling channel fins 154, which in this instance are inwardly protruding fins that are also vertically oriented. The coolant channel fins could have other designs, such as fins that provide a serpentine or tortuous flow path, or other configuration. The cooling channel fins can provide an increase in cooling channel material or surface area for contact between the coolant and interior surface of the cooling channel, thus providing a more efficient thermal exchange or transfer from the coolant to the warmer temperature at the exterior surface of the water collector.

Also shown at A-A is an example view of an upper surface of a connection plate 170 of the coolant supply manifold 166 having a plurality of water collectors 150 positioned thereon. Water collectors each include exterior condenser fins 152 protruding outwardly and cooling channel fins 154 protruding inwardly in this example. Also shown is a coolant return opening 176 that passes through the connection plate, and in this instance, is used to supply coolant 158 (that has been cooled at a sub-surface cooling region 164 or some other cooling source) to the coolant supply manifold between the connection plate and the coolant channeling plate 170 for delivery in an upward direction in parallel through the cooling channels 156 of the respective water collectors. As noted with respect to FIG. 1, though not shown, the condensation assemblies may be arranged so that the coolant supply manifold is present at the top of the water collectors and the coolant return manifold is positioned at the bottom of the water collectors, thus providing downward flow of coolant through the coolant channel of the water collectors.

Not shown in the FIGS., but relevant to all of the purified water collection disclosure herein, in some examples, the water purification systems, and particularly the condensation assemblies can include additional components for treating or maintaining the improved purity of the purified water. For example, the water purification systems can include components for filtration and/or treatment for germicidal activity, etc. at or after the condensation assemblies. Air filters can be used to remove pollutants that may be present in the air within the enclosed chamber, e.g., pollen, dust, etc. Water collection equipment, such as pipes, water collectors, manifolds, purified water-receiving vessels, valves, etc., can be treated to prevent mold, bacteria, or other microorganisms from forming or flourishing. Volatile organic compounds (VOCs), for example, may be able to be removed or partially removed from the impure water source in some instances, or after forming the (more) purified water, using filters such as carbon filters. Microorganisms can also be treated by using UV or other spectra of light, by ozonation, or by other technique to kill microorganisms on equipment or within the purified water. In other words, the water purification systems, condensation assemblies, and/or other equipment described herein can further benefit, in some instances, by the use of mechanical air filters, carbon filters, light-energy pathogen treatment devices, ozonators, and/or food-grade coating, etc.

Furthermore, the water purification systems, or any sub-component thereof, e.g., evaporation towers, condensation assemblies, etc., can be controlled by a variety of automated and/or manual systems. In one example, a computerized control system can be used to control any of the devices used in conjunction with the impure water evaporative separation system or evaporation tower and/or the condensation assembly. For example, the computerized control system can control valves, rotational nozzles, fixed nozzles, rotational platforms, timers, sensors, fluid pumps, fans, pressure regulation within the enclosed chamber, etc. For example, sensing or modifying temperatures within the enclosed chamber, sensing relative humidity within an interior region of the evaporation tower and/or within one or more region within the enclosed chamber, using timers, providing automated impure water loading based on timing or sensor-driven analytics, sensing pressure within the enclosed chamber, adjusting pressure within the enclosed chamber, sensing cooling or condensation at the condensation assembly, adjusting temperature provided to the condensation assembly, or the like, can be used to automatically determine when the water purification system or any sub-component thereof should run, when and/or how the evaporation tower should be loaded with impure water, when and/or how the condensation assembly should run, etc. In one example, an environmental sensor or a weather forecast can be used to provide shutdown information to avoid freezing or overheating.

A computerized console can also be used to measure and/or store/transmit data related to water volume pumped per unit of time, e.g., per minute, per hour, per day, per month, etc., to measure and/or store/transmit data water depth of a pond or ponds serviced by an evaporation tower, and/or to measure and/or store/transmit data related to water collection at the condensation assembly, for example. The computerized console can be configured to be locked so that it is inaccessible without an access code, key, or both. Even with computer control and/or automated systems, the system can also be configured to include a manual valve management override system in case there is a computer console power loss or malfunction. There can also be an on-site camera system in place (digital photos or video, for example) for management and monitoring of pumps, valves, nozzles, platforms, timers, sensors, etc. The system can control and/or communicate remotely with a user at a computer interface, or automatically with a computer, using the internet and appropriate wireless communication protocols and/or Ethernet line communication. Data collected can be stored and/or analyzed continuously or at various intervals, including data such as ambient condition data points (general weather, temperature, relative humidity, precipitation, wind, water in, water out, relative humidity within the evaporation panel assembly compared to ambient relative humidity, etc.). Settings can be changed remotely using the computer system, for example.

Power sources that can be used include city power where available, e.g., generator power by natural gas, diesel, propane, etc., solar power (which can be by solar panels placed on or adjacent to the evaporation panel assembly), etc. Secondary backup power with automatic transfer or power backup battery bank for graceful shutdown purposes can also be implemented, or to maintain power until the regular power source is restored. As an example, as mentioned, solar panels can provide a way of operating the water purification system off of the power grid, for example, in some instances providing net zero or even negative environmental impact.

Other systems that may be utilized, either by automated or manual control, can include the use of equipment to provide a better balance between the volume or weight evaporation occurring at the evaporation tower(s) within the evaporation region and the volume or weight of condensed purified water collected at the condensation assembly or assemblies. Equalization, or even dosing the gap to any degree between the amount of evaporation and condensation that occurs, can benefit the efficiency of the system. The weight or volume ratio of evaporation to condensation can vary depending on environmental conditions, and thus, the water purification system can include equipment and/or systems to assist with balancing or dosing the gap related to the evaporation and condensation that occurs. In one example, by modifying the pressure within the enclosed chamber, the ratio of evaporation to condensation can be likewise modified. For example, if there is more evaporation occurring than condensation, raising the pressure within the enclosed chamber can reduce the amount of evaporation and increase the amount of condensation. If there is less evaporation and potentially more condensation possible, then the pressure could be lowered to enhance the evaporation and reduce the condensation that may be possible. In some examples, the enclosed chamber can be a more rigid structure or structure suited for accommodating and retaining pressure changes. Such a structure may be something similar to a framed greenhouse or more permanent structure or building that could accommodate larger pressure changes. With such a structure suitable for accommodating pressure modifications, this pressure adjustment methodology is one example of a system that could be used to provide a more optimal balance (or close the gap) between evaporation output into the enclosed chamber and condensation collection and the condensation assembly, for example. In other examples, as mentioned, temperature changes can be used similarly with an increase or reduction of heat within the enclosed chamber, e.g., pointing sunlight-redirecting optics toward or away from the evaporation towers, venting the enclosed chamber, turning on/off heating elements, etc. In another example, a fog harvester or fog harvest screen associated with a water collection gutter could be included anywhere within the enclosed chamber to mop up excess water vapor to be collected by the fog harvest screen and ultimately channeled by a gutter or other fluid directing channel. A fog harvester benefits from the presence of airflow, and thus, the fan shown in FIG. 1 could be used in connection with the fog harvester, for example. Still other systems could likewise be used where there may be excess evaporation compared to condensation at the condensation assemblies (or vice versa).

Turning now to FIG. 21, a method 500 of purifying impure water in an enclosed chamber can include generating 510 water vapor from impure water within an evaporation region of an enclosed chamber to form humidified air by cascading the impure water downward from shelf to shelf of an evaporation tower. The method can also include condensing 520 the water vapor within a condensation region of the enclosed chamber at an exterior surface of a water collector that is cooled to a temperature below a dew point of the humidified air holding the water vapor to generate purified water by condensation at the exterior surface of the water collector; and collecting 530 the purified water formed by condensation as runoff from the exterior surface into a purified water-receiving vessel.

Regarding the evaporation region, generating water vapor can include cycling the impure water from a reservoir source of the impure water to an upper shelf of the evaporation tower. The impure water can cascade downward to a series of relative lower shelves of the evaporation tower and then return to the reservoir source for further cycling. The method can also include directing the humidified air from the evaporation region to the condensation region for water collection at the water vapor condenser. Other steps may include heating the humidified air within an evaporation region of the enclosed chamber to an elevated temperature greater than an ambient air temperature surrounding the enclosed chamber. The humidified air can be from 90% saturated to fully saturated at the elevated temperature, which provides a higher amount of water vapor present in the air by weight than would be available at the ambient air temperature. The elevated temperature on average within the evaporation region can be from about 20° F. to about 120° F. greater than the ambient air temperature, or the elevated temperature within the evaporation region has an average temperature from about 80° F. to about 200° F. In other examples, the elevated temperature within the evaporation region can have an average temperature from about 120° F. to about 200° F. The humidified air at the elevated temperature within the enclosed chamber carries at least twice, at least five times, or at least ten times a unit weight of water per weight of air, compared to the ambient air (surrounding the enclosed chamber) at the ambient temperature. In some examples, heating can include redirecting or concentrating sunlight energy within the evaporation region of the enclosed chamber, and/or heating can include introducing heat to the evaporation region using a radiant heating source, an IR heating source, a forced air heating source, a flanged heating source, a circulation or inline heating source, a hydrocarbon heating source, or a combination thereof. The evaporation region can include multiple evaporation towers, with each configured to receive and increase the surface area of impure water while cascading downward from its upper shelf to lower shelves therebeneath as water evaporates therefrom and forms water vapor within the enclosed chamber. The evaporation region can be partially enclosed with a transparent material, a translucent material, a black material, a heat absorbing material, or a combination thereof.

Regarding the condensation region of the enclosed chamber, the water collector can be part of a plurality of water collectors present on a condensation assembly. The condensation assembly can include the plurality of water collectors which individually include an interior surface defining a cooling channel, a cooling channel to transport coolant therethrough when present, and an exterior surface providing a path for runoff of the purified water. The exterior surface can also be thermally coupled to the interior surface of the cooling channel facilitating cooling of the exterior surface by heat exchange between the inner surface and the exterior surface. The condenser assembly can further include a coolant return fluidly coupled to the plurality of water collectors as part of a closed-loop system to cycle and cool coolant after exiting the cooling channel to be re-supplied independently to the cooling channels of the respective plurality of water collectors. The condenser assembly can include a purified water-receiving vessel fluidly coupled to the exterior surface of the plurality of water collectors to collect the purified water after the runoff from the exterior surface. The exterior surface of the water collector can include a plurality of exterior condenser fins. The inner surface of the water collector can likewise include a plurality of cooling channel fins. The closed-loop system can be charged and carry the coolant which is circulated through the plurality of cooling channels and the coolant return. In some examples, the coolant can include a glycol coolant. In other examples, the coolant can include propylene glycol, ethylene glycol, sodium chloride, calcium chloride, brine, CFC-based compound, HFC-based compound, ammonia, water, or a combination thereof. The coolant return can be routed to a cooling area at a distal location relative to the plurality of water collectors, e.g., a sub-surface region. Examples may be sub-surface regions underground or under a body of water, such as a lake, a river, seawater, wastewater, etc. The cooling channels can be arranged in parallel and collectively connected in series with a coolant return.

In some examples, the condensation assembly can include a coolant supply manifold that fluidly couples the coolant return with the cooling channels arranged in parallel at respective ingress openings thereof; a coolant return manifold that fluidly couples the coolant return with the cooling channels arranged in parallel at respective egress openings thereof; or both. The purified water-receiving vessel can be a purified water-receiving pan positioned beneath the plurality of water collectors and/or can be a purified water-receiving tank positioned to receive the purified water after being channeled from the plurality of water collectors via a purified water line. The condensation region can be partially enclosed with a white material, a heat resistant material, a reflective material, or a combination thereof.

In some examples, the method can include directing airflow to move humidified air from the evaporation region to the condensation region, such as by the use of a fan or other methods of moving air, though in some examples, there may not be any airflow inducing device present. As mentioned previously, the impure water may be from brine, e.g., BWRO brine concentrate, etc., brackish water, seawater, produced water, effluent water, contaminated water, storm runoff, river water, pond or lake water, gray water, black water, e.g., sewage, industrial wastewater, e.g., pulp/paper, textile dye, chemical plant, cooling water, etc., irrigation water, mining wastewater, oil or gas wastewater, or a combination thereof. There may be other impure water sources that can likewise be used, as would be appreciated by one skilled in the art after considering the present disclosure.

While the above examples, description, and drawings are illustrative of the principles of the present technology in one or more particular applications, it will be apparent to those of ordinary skill in the art that numerous modifications in form, usage and details of implementation can be made without the exercise of inventive faculty, and without departing from the principles and concepts of the present disclosure.

What is claimed is:

1. A water purification system, comprising an enclosed chamber including an evaporation region and a condensation region,
the evaporation region comprising:
an evaporation tower including a series of shelves to receive and increase a surface area of impure water while cascading downward from an upper shelf to lower shelves therebeneath as water evaporates therefrom to form water vapor within the enclosed chamber,
a fluid directing assembly to cyclically transport the impure water from a reservoir source to the upper shelf, and
the condensation region comprising:
a purified water-receiving vessel, and
a plurality of water collectors, wherein individual water collectors of the plurality of water collectors include an exterior surface coolable to a temperature below a dew point of air carrying the water vapor and shaped to channel water formed thereon by condensation to the purified water-receiving vessel.

2. The water purification system of claim 1, wherein the evaporation tower includes an evaporation panel assembly including:
a plurality of evaporation panels arranged in evaporation panel sub-assemblies,
a plurality of horizontally oriented upper evaporation shelves positioned over a series of lower evaporation shelves,
multiple evaporation panels orthogonally joined together, or
a combination thereof.

3. The water purification system of claim 1, wherein the series of shelves are horizontally oriented and vertically stacked and separated by support columns.

4. The water purification system of claim 3, wherein the support columns include a plurality of stacked and spaced apart evaporation fins oriented in parallel with the series of evaporation shelves.

5. The water purification system of claim 4, wherein the evaporation fins have the shape of a perpendicular cross-section of an airfoil.

6. The water purification system of claim 3, wherein the evaporation tower comprises orthogonally connected evaporation panels.

7. The water purification system of claim 6, wherein the evaporation panels individually include:
a plurality of female receiving openings which are individually bordered by two evaporation shelves and two support columns,
a plurality of male connectors positioned at both lateral ends of the respective evaporation panel joined at one or both ends with corresponding female receiving openings of orthogonally oriented evaporation panels.

8. The water purification system of claim 1, wherein the fluid directing assembly includes a water pump and a water distributor positioned at an upper surface of the evaporation tower.

9. The water purification system of claim 8, wherein the water distributor includes a sprayer nozzle, a distribution pan, a distribution trough, or a combination thereof.

10. The water purification system of claim 1, further comprising a heating source to increase a temperature of the evaporation region above an ambient temperature surrounding the enclosed chamber to provide humidified air with a higher water-holding capacity than that of the ambient temperature.

11. The water purification system of claim 10, wherein the heating source includes optics for directing or concentrating sunlight energy within the evaporation region of the enclosed chamber.

12. The water purification system of claim 11, wherein the optics includes a series of sunlight-redirecting optics positioned outside of the enclosed chamber which direct the sunlight energy through a transparent or translucent wall defining at least a portion of the enclosed chamber.

13. The water purification system of claim 10, wherein the heating source is a radiant heating source, an IR heating source, a forced air heating source, a flanged heating source, a circulation or inline heating source, a hydrocarbon heating source, or a combination thereof.

14. The water purification system of claim 1, wherein the evaporation region includes multiple evaporation towers, each configured to receive and increase the surface area of impure water while cascading downward from its upper shelf to lower shelves therebeneath as water evaporates therefrom and forms water vapor within the enclosed chamber.

15. The water purification system of claim 1, wherein the purified water-receiving vessel includes a purified water-receiving pan positioned beneath the plurality of the water collectors.

16. The water purification system of claim 15, wherein the purified water-receiving vessel includes a purified-water receiving tank fluidly coupled to the collection pan by a fluid directing channel.

17. The water purification system of claim 1, wherein the water collectors are upright pillars or posts having an orientation to allow purified water from water condensation to flow downward along a surface thereof to be collected by a purified water-receiving vessel positioned therebeneath.

18. The water purification system of claim 1, wherein the exterior surface of the individual water collectors include a plurality of outwardly protruding exterior condenser fins.

19. The water purification system of claim 1, wherein the individual water collectors include a cooling channel, wherein the exterior surface of individual water collectors are thermally coupled to the cooling channel to cool the exterior surface by heat exchange.

20. The water purification system of claim 19, wherein the cooling channel contains a coolant.

21. The water purification system of claim 20, wherein the coolant includes a glycol compound.

22. The water purification system of claim 19, wherein the cooling channel is part of a closed loop system that is fluidly arranged to cycle coolant from within the individual water collector to a cooling area at a distal location where coolant is cooled for cycling back to within the cooling channel.

23. The water purification system of claim 22, wherein the cooling area is a sub-surface cooling region located underground or underwater.

24. The water purification system of claim 22, wherein the plurality of water collectors include from 2 to 128 individual water collectors, wherein the individual water collectors independently include a cooling channel, wherein multiple cooling channels of multiple water collectors are fluidly arranged in parallel, and wherein the multiple cooling channels are collectively connected in series with fluidics at the cooling area.

25. The water purification system of claim 24, wherein the cooling channels fluidly arranged in parallel for upward flow of coolant in parallel.

26. The water purification system of claim 1, wherein the evaporation region is partially enclosed with a transparent material, a translucent material, a black or heat absorbing material, or a combination thereof.

27. The water purification system of claim 1, wherein the condensation region is partially enclosed with a white material, a heat resistant material, a reflective material, or a combination thereof.

28. The water purification system of claim 1, further comprising:
an airflow directing device to move humidified air from the evaporation region to the condensation region;
a fog harvester to collect additional purified water; or
both.

29. The water purification system of claim 1, further comprising a pressure control system to modify the pressure within the enclosed chamber to:
increase pressure to reduce evaporation of the impure water and increase condensation of the purified water;
reduce pressure to increase evaporation of the impure water and decrease condensation or potential condensation of the purified water; or
both.

30. The water purification system of claim 1, wherein the impure water is brine, brackish water, seawater, produced water, effluent water, contaminated water, storm runoff, river water, pond or lake water, gray water, industrial wastewater, irrigation water, mining wastewater, oil or gas wastewater, or a combination thereof.

31. A condensation assembly, comprising:
a plurality of water collectors to condense water vapor and form purified water, wherein at least one water collector thereof includes:
an interior surface defining a cooling channel, the cooling channel to transport coolant therethrough when the coolant is present, and
an exterior surface providing a path for runoff of the purified water, the exterior surface also being thermally coupled to the interior surface of the cooling channel facilitating cooling of the exterior surface by heat exchange between the inner surface and the exterior surface;
a coolant return fluidly coupled to the at least one water collector as part of a closed-loop system to cycle and cool coolant after exiting the cooling channel to be re-supplied to the cooling channel of the at least one water collector; and
a purified water-receiving vessel fluidly coupled to the exterior surface of the at least one water collector to collect the purified water after the runoff from the exterior surface.

32. The condensation assembly of claim 31, wherein the exterior surface includes a plurality of exterior condenser fins.

33. The condensation assembly of claim 31, wherein the inner surface of the cooling channel includes a plurality of cooling channel fins.

34. The condensation assembly of claim 31, wherein the closed-loop system is charged and carries the coolant for circulation through the at least one cooling channel and the coolant return.

35. The condensation assembly of claim 34, wherein the coolant includes a glycol coolant.

36. The condensation assembly of claim 34, wherein the coolant includes propylene glycol, ethylene glycol, sodium chloride, calcium chloride, brine, CFC-based compound, HFC-based compound, ammonia, water, or a combination thereof.

37. The condensation assembly of claim 31, wherein coolant return is routed to a cooling area at a distal location relative to the plurality of water collectors.

38. The condensation assembly of claim 37, wherein the cooling area is a sub-surface cooling region located underground or underwater.

39. The condensation assembly of claim 31, wherein the plurality of water collectors include from 2 to 128 individual water collectors, wherein the individual water collectors independently include a cooling channel fluidly arranged in parallel with another cooling channel or cooling channels.

40. The condensation assembly of claim 39, and wherein cooling channels arranged in parallel are collectively connected in series with a coolant return.

41. The condensation assembly of claim 40, further comprising a coolant supply manifold that fluidly couples the coolant return with the cooling channels arranged in parallel at respective ingress openings thereof.

42. The condensation assembly of claim 41, wherein the coolant supply manifold includes a connection plate joined with a coolant channeling plate.

43. The condensation assembly of claim 42, wherein the connection plate includes a purified water-receiving pan as the purified water-receiving vessel.

44. The condensation assembly of claim 42, wherein the coolant channeling plate includes open coolant channels and a plurality of protrusions that partially define the open coolant channels.

45. The condensation assembly of claim 44, wherein the open coolant channels are aligned to permit coolant flow though connection plate at water collector connectors that are independently sealed to the water collectors.

46. The condensation assembly of claim 40, further comprising a coolant return manifold that fluidly couples the coolant return with the cooling channels arranged in parallel at respective egress openings thereof.

47. The condensation assembly of claim 31, wherein the purified water at the exterior surface is formed at a temperature below a dew point of air carrying the water vapor about the exterior surface.

48. The condensation assembly of claim 31, wherein the exterior fins are vertically oriented and arranged about a central tubular structure.

49. The condensation assembly of claim 31, wherein the purified water-receiving vessel is a purified water-receiving pan positioned beneath the plurality of water collectors.

50. The condensation assembly of claim 31, wherein the purified water-receiving vessel is a purified water-receiving tank positioned to receive water channeled from the plurality of water collectors via a purified water line.

51. A method of purifying impure water in an enclosed chamber, comprising:
generating water vapor from impure water within an evaporation region of an enclosed chamber to form humidified air by cascading the impure water downward from shelf to shelf of an evaporation tower;
condensing the water vapor within a condensation region of the enclosed chamber at an exterior surface of a water collector that is cooled to a temperature below a dew point of the humidified air holding the water vapor to generate purified water by condensation at the exterior surface of the water collector; and
collecting the purified water formed by condensation as runoff from the exterior surface into a purified water-receiving vessel.

52. The method of claim 51, wherein generating water vapor includes cycling the impure water from a reservoir source of the impure water to an upper shelf of the evaporation tower, the impure water cascading downward to a series of relative lower shelves of the evaporation tower and then returning the impure water to the reservoir source for further cycling.

53. The method of claim 51, further comprising directing the humidified air from the evaporation region to the condensation region for water collection at the water vapor condenser.

54. The method of claim 51, further comprising heating the humidified air within an evaporation region of the enclosed chamber to an elevated temperature greater than an ambient air temperature surrounding the enclosed chamber, wherein the humidified air is from 90% saturated to fully saturated at the elevated temperature saturated providing a higher amount of water vapor present in the air by weight than would be available at the ambient air temperature.

55. The method of claim 54, wherein the elevated temperature on average within the evaporation region is from 20° F. to 120° F. greater than the ambient air temperature.

56. The method of claim 54, wherein the elevated temperature within the evaporation region has an average temperature from 80° F. to 200° F.

57. The method of claim 54, wherein the elevated temperature within the evaporation region has an average temperature from 120° F. to 200° F.

58. The method of claim 54, wherein the humidified air at the elevated temperature within the enclosed chamber carries at least twice a unit weight of water per weight of air as ambient air at the ambient temperature.

59. The method of claim 54, wherein the humidified air at the elevated temperature within the enclosed chamber carries at least five times a unit weight of water per unit weight of air as ambient air at the ambient temperature.

60. The method of claim 54, wherein the humidified air at the elevated temperature within the enclosed chamber carries at least ten times a unit weight of water per unit weight of air as ambient air at the ambient temperature.

61. The method of claim 54, wherein heating includes redirecting or concentrating sunlight energy within the evaporation region of the enclosed chamber.

62. The method of claim 54, wherein heating includes introducing heat to the evaporation region using a radiant heating source, an IR heating source, a forced air heating source, a flanged heating source, a circulation or inline heating source, a hydrocarbon heating source, or a combination thereof.

63. The method of claim 51, wherein the evaporation region includes multiple evaporation towers, each configured to receive and increase the surface area of impure water while cascading downward from its upper shelf to lower shelves therebeneath as water evaporates therefrom and forms water vapor within the enclosed chamber.

64. The method of claim 51, wherein the water collector is part of a plurality of water collectors present on a condensation assembly.

65. The method of claim 64, the condensation assembly comprising:
the plurality of water collectors individually including:
an interior surface defining a cooling channel, the cooling channel to transport coolant therethrough when present, and
the exterior surface providing a path for runoff of the purified water, the exterior surface also being thermally coupled to the interior surface of the cooling channel facilitating cooling of the exterior surface by heat exchange between the inner surface and the exterior surface.

66. The method of claim 65, wherein the condenser assembly further comprises a coolant return fluidly coupled to the plurality of water collectors as part of a closed-loop system to cycle and cool coolant after exiting the cooling channel to be re-supplied independently to the cooling channels of the respective plurality of water collector.

67. The method of claim 65, wherein the condenser assembly further comprises a purified water-receiving vessel fluidly coupled to the exterior surface of the plurality of water collectors to collect the purified water after the runoff from the exterior surface.

68. The method of claim 65, wherein the exterior surface of the water collector includes a plurality of exterior condenser fins.

69. The method of claim 65, wherein the inner surface of the water collector includes a plurality of cooling channel fins.

70. The method of claim 66, wherein the closed-loop system is charged and carries the coolant which includes circulating the coolant through the plurality of cooling channels and the coolant return.

71. The method of claim 66, wherein the coolant includes a glycol coolant.

72. The method of claim 66, wherein the coolant includes propylene glycol, ethylene glycol, sodium chloride, calcium chloride, brine, CFC-based compound, HFC-based compound, ammonia, water, or a combination thereof.

73. The method of claim 66, wherein the coolant return is routed to a cooling area at a distal location relative to the plurality of water collectors.

74. The method of claim 73, wherein the cooling area is located at a sub-surface cooling region located underground or underwater.

75. The method of claim 66, and wherein cooling channels arranged in parallel are collectively connected in series with a coolant return.

76. The method of claim 66, further comprising:
a coolant supply manifold that fluidly couples the coolant return with the cooling channels arranged in parallel at respective ingress openings thereof;
a coolant return manifold that fluidly couples the coolant return with the cooling channels arranged in parallel at respective egress openings thereof; or
both.

77. The method of claim 65, wherein the purified water-receiving vessel is a purified water-receiving pan positioned beneath the plurality of water collectors.

78. The method of claim 65, wherein the purified water-receiving vessel is a purified water-receiving tank positioned to receive the purified water after being channeled from the plurality of water collectors via a purified water line.

79. The method of claim 51, wherein the evaporation region is partially enclosed with a transparent material, a translucent material, a black material, a heat absorbing material, or a combination thereof.

80. The method of claim 51, wherein the condensation region is partially enclosed with a white material, a heat resistant material, a reflective material, or a combination thereof.

81. The method of claim 51, furthering comprising directing airflow to move humidified air from the evaporation region to the condensation region.

82. The method of claim 51, wherein the impure water includes brine, brackish water, seawater, produced water, effluent water, contaminated water, storm runoff, river water, pond or lake water, gray water, industrial wastewater, irrigation water, mining wastewater, oil or gas wastewater, or a combination thereof.
